(19) United States
(12) Patent Application Publication
(10) Pub. No.: US 2024/0089983 A1
(43) Pub. Date: Mar. 14, 2024

(54) SYSTEMS AND METHODS FOR CONTROL OF CONFIGURED UL AND DL TRANSMISSIONS

(71) Applicant: Telefonaktiebolaget LM Ericsson (publ), Stockholm (SE)

(72) Inventors: Havish KOORAPATY, SARATOGA, CA (US); Stephen GRANT, PLEASANTON, CA (US); Peter ALRIKSSON, HÖRBY (SE); Hazhir SHOKRI RAZAGHI, SOLNA (SE)

(21) Appl. No.: 17/766,817

(22) PCT Filed: Oct. 7, 2020
(86) PCT No.: PCT/EP2020/078141

§ 371 Date: Apr. 6, 2022

Related U.S. Application Data
(60) Provisional application No. 62/911,804, filed on Oct. 7, 2019.
(60) Provisional application No. 62/936,950, filed on Nov. 18, 2019.

(51) Int. Cl. H04W 72/232; H04L 5/14; H04W 72/1268; H04W 74/08

(52) U.S. Cl. CPC H04W 72/232; H04L 5/1469; H04W 72/1268; H04W 74/0816

(57) ABSTRACT

Systems and methods are disclosed for control of configured transmissions in a cellular communications system. A method performed by a wireless communication device includes receiving, from a base station, a configuration of a set of symbols for one or more configured transmissions and monitoring for a Downlink Control Information (DCI) that uses a particular DCI format. The method further includes, when the wireless communication device does not detect a DCI that uses the particular DCI format and either: (a) a semi-static Time Division Duplexing (TDD) configuration received by the wireless communication device indicates the set of symbols configured for the one or more configured transmissions as flexible or (b) the wireless communication device did not receive a semi-static TDD configuration, making a determination of whether the one or more configured transmissions are allowed to be transmitted or are received based on whether a parameter is configured.

### RELATED APPLICATIONS

This application claims the benefit of provisional patent application Ser. No. 62/911,804, filed Oct. 7, 2019 and provisional patent application Ser. No. 62/936,950, filed Nov. 18, 2019, the disclosures of which are hereby incorporated herein by reference in their entireties.

### TECHNICAL FIELD

The present disclosure relates to configured uplink and downlink transmissions in a cellular communications system.

### BACKGROUND

Mobile broadband will continue to drive the demands for big overall traffic capacity and huge achievable end-user data rates in the wireless access network. Several scenarios in the future will require data rates of up to 10 Gigabits per second (Gbps) in local areas. These demands for very high system capacity and very high end-user date rates can be met by networks with distances between access nodes ranging from a few meters in indoor deployments up to roughly 50 meters (m) in outdoor deployments, i.e. with an infra-structure density considerably higher than the densest networks of today. Such networks are referred to herein as New Radio (NR) systems. NR is currently being specified in the Third Generation Partnership Project (3GPP) specifications. Besides traditional licensed exclusive bands, NR systems are also expected to operate on unlicensed bands, especially for enterprise solutions. This topic has been discussed in 3GPP, beginning with a study item in the middle of 2017.

### Numerology and Bandwidth Consideration for NR

Multiple numerologies are supported in NR. A numerology is defined by subcarrier spacing and Cyclic Prefix (CP) overhead. Multiple subcarrier spacings can be derived by scaling a basic subcarrier spacing by an integer 2ⁿ. The numerology used can be selected independently of the frequency band, although it is assumed not to use a very small subcarrier spacing at very high carrier frequencies. Flexible network and User Equipment (UE) channel bandwidth is supported.

From the RAN1 specification perspective, the maximum channel bandwidth per NR carrier is 400 Megahertz (MHz) in Release 15 (Rel-15). Note that all details for channel bandwidth at least up to 100 MHz per NR carrier are to be specified in Rel-15. At least for the single numerology case, candidates for the maximum number of subcarriers per NR carrier is 3300 or 6600 in Rel-15 from RAN1 specification perspective. NR channel designs should consider potential future extension of these parameters in later releases, allowing a Rel-15 UE to have access to NR network on the same frequency band in later releases.

A subframe duration is fixed to 1 milliseconds (ms), and the frame length is 10 ms. Scalable numerology should allow at least from 15 kilohertz (kHz) to 480 kHz subcarrier spacing. All numerologies with 15 kHz and larger subcarrier spacing, regardless of CP overhead, align on symbol boundaries every 1 ms in NR carrier. More specifically, for the normal CP family, the following is adopted.

For subcarrier spacing of 15 kHz * 2ⁿ (n is non-negative integer),

| | - | Each symbol length (including CP) of 15 kHz subcarrier spacing equals the sum of the |
|---|---|---|
| | | corresponding 2ⁿ symbols of the scaled subcarrier spacing. |
| | - | Other than the first OFDM symbol in every 0.5ms, all OFDM symbols within 0.5ms |
| | | have the same size |
| | - | The first OFDM symbol in 0.5ms is longer by 16Tₛ (assuming 15 kHz and FFT size of |
| | | 2048) compared to other OFDM symbols. |
| | | - 16 Tₛ is used for CP for the first symbol. |
| - | For subcarrier spacing of 15 kHz * 2ⁿ (n is a negative integer) | |
| | - | Each symbol length (including CP) of the subcarrier spacing equals the sum of the |
| | | corresponding 2⁻ⁿ symbols of 15 kHz. |

### NR Frame Structure

The next generation mobile wireless communication system (5G), or NR, supports a diverse set of use cases and a diverse set of deployment scenarios. The later includes deployment at both low frequencies (100s of Megahertz (MHz)), similar to Long Term Evolution (LTE) today, and very high frequencies (millimeter (mm) waves in the tens of Gigahertz (GHz)).

Similar to LTE, NR uses Orthogonal Frequency Division Multiplexing (OFDM) in the downlink (i.e. from a network node, gNB, eNB, or base station, to a UE). The basic NR physical resource over an antenna port can thus be seen as a time-frequency grid as illustrated in FIG. 1, where a resource block (RB) in a 14-symbol slot is shown. A resource block corresponds to 12 contiguous subcarriers in the frequency domain. Resource blocks are numbered in the frequency domain, starting with 0 from one end of the system bandwidth. Each resource element corresponds to one OFDM subcarrier during one OFDM symbol interval.

Different subcarrier spacing values are supported in NR. The supported subcarrier spacing values (also referred to as different numerologies) are given by Δf=(15×2\hat{ }α) kHz where α∈(0, 1, 2, 3, 4). Δf=15 kHz is the basic (or reference) subcarrier spacing that is also used in LTE.

In the time domain, downlink and uplink transmissions in NR will be organized into equally-sized subframes of 1 ms each, similar to LTE. A subframe is further divided into multiple slots of equal duration. The slot length for subcarrier spacing Δf=(15×2\hat{ }α) kHz is ½\hat{ }α ms. There is only one slot per subframe for Δf=15 kHz and a slot consists of 14 OFDM symbols.

Downlink transmissions are dynamically scheduled, i.e., in each slot the gNB transmits downlink control information (DCI) about which UE data is to be transmitted to and which resource blocks in the current downlink slot the data is transmitted on. This control information is typically transmitted in the first one or two OFDM symbols in each slot in NR. The control information is carried on the Physical Downlink Control Channel (PDCCH) and data is carried on the Physical Downlink Shared Channel (PDSCH). A UE first detects and decodes PDCCH and if a PDCCH is decoded successfully, it then decodes the corresponding PDSCH based on the downlink assignment provided by decoded control information in the PDCCH.

In addition to PDCCH and PDSCH, there are also other channels and reference signals transmitted in the downlink, including Synchronization Signal Block (SSB), Channel State Information Reference Signal (CSI-RS), etc. Sometimes a set of SSBs and the corresponding System Information Block 1 (SIB1) transmissions are grouped together and referred to as a Discovery Reference Signal (DRS). The DRS can also optionally include CSI-RS transmissions.

Uplink data transmissions, which are carried on Physical Uplink Shared Channel (PUSCH), are also dynamically scheduled by the gNB by transmitting a DCI. The DCI (which is transmitted in the DL region) always indicates a scheduling offset so that the PUSCH is transmitted in a slot in the UL region.

Uplink and downlink data transmissions that are not dynamically scheduled but that are configured by higher layers to occur at specific instances in configured resources are also possible in NR. A number of uplink transmissions can occur in this manner including PUSCH or PUCCH transmissions carrying channel state feedback, data, or scheduling requests. Transmissions in these resources can occur without the reception of any additional downlink signals prior to each transmission such as a PDCCH carrying a scheduling command.

### TDD Uplink-Downlink Configuration in NR

In NR, both semi-statically configured Time Division Duplexing (TDD) and dynamic TDD are supported. For the latter, the scheduling DCI (DL assignment/UL grant) indicates which symbols within a slot are to be used for downlink reception and uplink transmission by the UE.

For semi-static TDD, the configuration of uplink-downlink patterns is very flexible. For a particular slot within the TDD pattern, symbols may be configured as either downlink (denoted ‘D’), uplink (denoted ‘U’), or flexible (denoted ‘F’). One use of symbols classified as ‘F’ is to create a guard period for DL-to UL or UL-DL transitions for half-duplex devices (half-duplex FDD or TDD). A cell-specific TDD pattern is either provided by SIB (standalone operation) or by RRC (non-standalone operation). Additionally, a UE-specific TDD pattern can be configured to override symbols of the cell-specific configuration which are classified as flexible (‘F’).

For dynamic TDD where the UL/DL allocation may vary depending on the scheduling DCI, it can be useful to indicate to a group of UEs what the instantaneous TDD pattern looks like for the current and potentially future slots. This is achieved through group common signaling (Group Common PDCCH (GC-PDCCH)) carrying a DCI message with Format 2_0. DCI Format 2_0 contains one or more Slot Format Indicators (SFIs) indicating which symbols are classified as ‘D’, ‘U’, or ‘F’ within each of the indicated slots.

### Semi-Static Uplink-Downlink Configuration

Cell-specific semi-static configuration of the TDD pattern(s) is provided from the network to the UE by the information element (IE) TDD-UL-DL-ConfigCommon, as defined in the following excerpt from 3GPP Technical Specification (TS) 38.331 V15.7.0):

| | |
|---|---|
| TDD-UL-DL-ConfigCommon ::= | SEQUENCE { |
| referenceSubcarrierSpacing | SubcarrierSpacing, |
| pattern1 | TDD-UL-DL-Pattern, |
| pattern2 | TDD-UL-DL-Pattern |

OPTIONAL, -- Need R
...
}

| | |
|---|---|
| TDD-UL-DL-Pattern ::= | SEQUENCE { |
| dl-UL-TransmissionPeriodicity | ENUMERATED {ms0p5, |

ms0p625, ms1, ms1p25, ms2, ms2p5, ms5, ms10},

| | |
|---|---|
| nrofDownlinkSlots | INTEGER |

(0..maxNrofSlots),

| | |
|---|---|
| nrofDownlinkSymbols | INTEGER |

(0..maxNrofSymbols−1),

| | |
|---|---|
| nrofUplinkSlots | INTEGER |

(0..maxNrofSlots),

| | |
|---|---|
| nrofUplinkSymbols | INTEGER |

```
(0..maxNrofSymbols−1),
  ...,
  [[
```

| | |
|---|---|
| dl-UL-TransmissionPeriodicity-v1530 | ENUMERATED {ms3, |
| | ms4} |

OPTIONAL -- Need R
]]
}

This IE provides the option to provide up to two concatenated TDD patterns (pattern1, pattern2) each with their own periodicity. There is a constraint that the concatenated pattern must have a total periodicity that divides 20 ms evenly in order to align with the default Synchronization Signal (SS)/Physical Broadcast Channel (PBCH) block periodicity of 20 ms assumed by the UE upon accessing a cell i.e. devices that are doing initial cell search or devices in inactive/idle state doing cell search for mobility.

For each of the one or two concatenated TDD patterns, the above IE defines the TDD pattern as follows:
number of full DL slots, where all symbols of these slots are classified as ‘D’ by nrofDownlinkSlots,
number of symbols classified as ‘D’ in a partial DL slot following the last full DL slot by nrofDownlinkSymbols,
number of symbols classified as ‘U’ in a partial UL slot preceding the first full UL by nrofUplinkSymbols,
number of full UL slots, where all symbols of these slots are classified as ‘U’ by nrofUplinkSlots, and
periodicity, in ms, after which the pattern repeats by dl-UL-TransmissionPeriodicity.
   All symbols not classified as either ‘D’ or ‘U’ are assumed to be classified as ‘F’.

FIG. 2 shows a few exemplary cell-specific TDD patterns that can be configured semi-statically by TDD-UL-DL-ConfigCommon.

As mentioned above, an individual UE can be semi-statically configured with a UE-specific TDD pattern that overrides parts of the cell-specifically configured pattern. UE-specific semi-static configuration of a TDD pattern is provided from the network to the UE by the information element TDD-UL-DL-ConfigDedicated. TDD-UL-DL-ConfigDedicated is defined in the following excerpt from 3GPP Technical Specification (TS) 38.331 V15.7.0 as:

| | |
|---|---|
| TDD-UL-DL-ConfigDedicated ::= | SEQUENCE { |
| slotSpecificConfigurationsToAddModList | SEQUENCE (SIZE |
| (1..maxNrofSlots)) OF | OPTIONAL, -- |
| TDD-UL-DL-SlotConfig | |

Need N

| | |
|---|---|
| slotSpecificConfigurationsToreleaseList | SEQUENCE (SIZE |
| (1..maxNrofSlots)) OF | OPTIONAL, -- |
| TDD-UL-DL-SlotIndex | |

Need N
...
}

| | |
|---|---|
| TDD-UL-DL-SlotConfig ::= | SEQUENCE { |
| slotIndex | TDD-UL-DL-SlotIndex, |
| symbols | CHOICE { |
| allDownlink | NULL, |
| allUplink | NULL, |
| explicit | SEQUENCE { |
| nrofDownlinkSymbols | INTEGER |
| (1..maxNrofSymbols−1) | OPTIONAL, |

-- Need S

| | |
|---|---|
| nrofUplinkSymbols | INTEGER |
| (1..maxNrofSymbols−1) | OPTIONAL |

```
-- Need S
    }
  }
}
```

| | |
|---|---|
| TDD-UL-DL-SlotIndex ::= | INTEGER |
| | (0..maxNrofSlots−1) |

This IE contains a list of slots within the cell-specific TDD pattern for which the symbol classification should be overridden; however, this override can only be applied to symbols classified as flexible (‘F’). For each indicated slot, the flexible symbols can be re-classified as ‘allDownlink’, ‘allUplink’, or ‘explicit’. For ‘explicit’, the number of symbols at the beginning of the slot classified as ‘D’ is configured, and the number of symbols at the end of the slot classified as ‘U’ is configured.

### Dynamic Indication of Uplink-Downlink Configuration by DCI Format 2_0

As mentioned above, in the case of dynamic TDD where the UL/DL allocation may vary depending on the scheduling DCI, it can be useful to indicate to a group of UEs what the instantaneous TDD pattern looks like for the current and potentially future slots. This is achieved by signaling of one or more SFIs in DCI Format 2_0 carried by the so-called GC-PDCCH. Each SFI indicates which symbols in a slot are classified as ‘D’, ‘U’, or ‘F’. The indicated SFI(s) cannot override symbols that are already semi-statically configured as ‘D’ or ‘U’; however, an SFI can indicate the direction (‘D’ or ‘U’) for symbols classified as flexible (‘F’). If the SFI indicates ‘F’ for symbols already classified as ‘F’, and PDCCH does not schedule any data or trigger reference signals in those symbols, then the UE shall neither transmit nor receive on those symbols. This can be useful to cancel an instance of a periodically transmitted/received reference signals (e.g., SRS, CSI-RS) to create ‘reserved resources’ for use by another technology, e.g., LTE. It can also be useful to create reserved resources (no transmission or reception by any UE) in the case that the SFI indicates ‘F’ for a symbol that is already semi-statically configured as ‘F’

In NR Unlicensed (NR-U), a semi-static/static indication of direction of transmission is not a viable option since the transmission from gNB depends on the Listen Before Talk (LBT) outcome and the gNB does not know when it can acquire the channel. The transmission direction would be decided on the spot and according to LBT success occasion. Thus, all the symbols can be considered as F before the channel is captured.

As already mentioned, in Rel-15, SFI is carried by DCI format 2_0, and the following information is transmitted as described in clause 7.3.1.3.1 in 3GPP TS 38.212 V15.7.0:

- Slot format indicator 1, Slot format indicator 2, ..., Slot format indicator N.

The size of DCI format 2_0 is configurable by higher layer parameter up to 128 bits.

Furthermore, as described in clause 11.1.1 in 3GPP TS 38.213 V15.7.0, each of the “Slot format indicators” or “SFI index” field in DCI format 2_0 indicates to a UE a slot format for each slot for a period of transmission for each DL bandwidth part (BWP) or each UL BWP starting from a slot where the UE detects the DCI format 2_0. This clause applies for a serving cell that is included in a set of serving cells configured by higher layer parameter SlotFormatIndicatorconfiguring GC-PDCCH carrying SFI. The parameter SlotFormatIndicator is defined by the following excerpt from 3GPP TS 38.331 V15.7.0:

-- ASN1START
-- TAG-SLOTFORMATINDICATOR-START
SlotFormatIndicator ::= SEQUENCE {

| | |
|---|---|
| sfi-RNTI | RNTI-Value, |
| dci-PayloadSize | INTEGER (1..maxSFI-DCI- |

PayloadSize),

| | |
|---|---|
| slotFormatCombToAddModList | SEQUENCE |

(SIZE(1..maxNrofAggregatedCellsPerCellGroup)) OF
SlotFormatCombinationsPerCell
OPTIONAL, -- Need N

| | |
|---|---|
| slotFormatCombToReleaseList | SEQUENCE |

(SIZE(1..maxNrofAggregatedCellsPerCellGroup)) OF ServCellIndex
OPTIONAL, -- Need N
...
}
-- TAG-SLOTFORMATINDICATOR-STOP
-- ASN1STOP

As can be seen in the above IE, the UE is provided sfi-RNTI and the payload size of DCI format 2_0 by dci-payloadSize.

Furthermore, for each serving cell in the set of serving cells indicated in SlotFormatIndicator, the UE can be provided with slotFormatCombinationsPerCell which configures the parameters used for interpretation of the field for each SFI-index for corresponding serving cell. The IE slotFormatCombinationsPerCell is defined in the following excerpt from 3GPP TS 38.331 V15.7.0:

-- ASN1START
-- TAG-SLOTFORMATCOMBINATIONSPERCELL-START

| | |
|---|---|
| SlotFormatCombinationsPerCell ::= | SEQUENCE { |
| servingCellId | ServCellIndex, |
| subcarrierSpacing | SubcarrierSpacing, |
| subcarrierSpacing2 | SubcarrierSpacing |

OPTIONAL, -- Need R

| | |
|---|---|
| slotFormatCombinations | SEQUENCE (SIZE |

(1..maxNrofSlotFormatCombinationsPerSet)) OF
SlotFormatCombination
OPTIONAL, -- Need M

| | |
|---|---|
| positionInDCI | INTEGER (0..maxSFI-DCI- |
| PayloadSize−1) | OPTIONAL, -- |

Need M
...
}

| | |
|---|---|
| SlotFormatCombination ::= | SEQUENCE { |
| slotFormatCombinationId | SlotFormatCombinationId, |
| slotFormats | SEQUENCE (SIZE |

(1..maxNrofSlotFormatsPerCombination)) OF INTEGER (0..255)
}

| | |
|---|---|
| SlotFormatCombinationId ::= | INTEGER |

(0..maxNrofSlotFormatCombinationsPerSet−1)
-- TAG-SLOTFORMATCOMBINATIONSPERCELL-STOP
-- ASN1STOP

According to the above IE, the following parameters are configured for each serving cell using the SlotFormatCombinationsPerCelt.
an identity of the serving cell by servingCellID
the location of SFI-index field (i.e. “slot format indicator x” in DCI format 2_0) by positionInDCI for corresponding servingCellID
A set of slot format combinations by slotFormatCombinations which comprise a sequence of SlotFormatCombinations. This can be interpreted as hash table where each “key” here indicated by SlotFormatCombinationID referring to a specific “slotFormatCombination” in the table, where each SlotFormatCombination includes two parameters:
   One or more slot formats (up to 256 slots) indicated by slotFormats
      The slotFormats comprise of sequence of indices from 0, . . . , 256. Each index refers to a slot format in the table 11.1.1-1 in clause 11.1.1. in [2] as explained below
   A mapping for the slot format combination provided by slotFormats to a corresponding SFI-index field value in DCI format 2_0 provided by the slotFormatCombinationID.

The NR specification (3GPP TS 38.213) contains a list of possible slot formats. An SFI is simply an integer that takes a value from the range (0 . . . 55) or the value 255. Values in the range (56 . . . 254) are reserved for future use. Each integer value simply points to a row in a table (see 3GPP TS 38.213), where each row indicates the classification for all 14 OFDM symbols of a slot.

### Rules for UL Transmissions Configured by Higher Layers (Configured UL Transmissions)

The NR specification (3GPP TS 38.213) specifies a set of rules that effect whether transmissions of various signals and channels such as PDCCH, PDSCH, PUSCH, PUCCH, SRS, CSI-RS, etc. are performed or not and the priority order between transmissions when DCI format 2_0 is configured to the UE. The rules specify UE behavior when DCI format 2_0 is configured. When DCI format 2_0 is configured, the rules govern behavior depending on whether a DCI format 2_0 message is detected or not, and if it is detected, the information provided in it.

The currently specified rules cover the following four scenarios:
UE is configured to monitor for DCI 2_0, and
   UE is configured with a semi-static TDD pattern (Scenario A-1), or
   UE is NOT configured with a semi-static TDD pattern (Scenario A-2)
UE is NOT configured to monitor for DCI 2_0, and
   UE is configured with a semi-static TDD pattern (Scenario B-1), or
   UE is NOT configured with a semi-static TDD pattern (Scenario B-2)
      In this scenario, the UE does not receive any indication of transmission direction, i.e., NO indication of ‘D’, ‘U’, or ‘F’
         In Scenarios A-1 and B-1, the UE is configured with TDD-UL-DL-ConfigurationCommon and potentially TDD-UL-DL-Configuration Dedicated which indicates the transmission direction, i.e., ‘D’, ‘U’, or ‘F’

As per currently specified rules, the UE may transmit any uplink transmissions configured by higher layers in a set of symbols in a slot that are indicated as ‘uplink’ or ‘flexible’ (‘U’ or ‘F’) in a semi-static TDD pattern (Scenario B-1) or that are not indicated a transmission direction (Scenario B-2). By “uplink transmissions configured by higher layers,” it is meant UL transmissions that are not transmitted in response to a downlink control information (DCI). Examples of such UL signals include PUCCH carrying scheduling requests (SRs), configured grant PUSCH transmissions, periodic SRS, and PRACH. In what follows, these will be referred to as “configured UL transmissions.”

However, for Scenarios A-1 and A-2, the UE may transmit configured UL transmissions in a set of symbols in a slot only if the symbols are indicated as uplink (‘U’) by the DCI 2_0 message. In other words, if the UE does not receive an indication of ‘U’ by DCI 2_0, then configured UL transmissions will be cancelled. There is one notable exception to this rule. In a duration of time immediately after the UE monitors for DCI 2_0, such transmissions are still allowed to occur. The duration of time depends on the UE processing capability, and is in the range 5 to 12 symbols. In 3GPP specifications, this duration of time is referred to as the “PUSCH preparation time.”

### SUMMARY

Systems and methods are disclosed herein for control of configured uplink or downlink transmissions in a cellular communications system. In one embodiment, a method performed by a wireless communication device comprises receiving, from a base station, a configuration of a set of symbols for one or more configured transmissions and monitoring for a Downlink Control Information (DCI) that uses a particular DCI format. The method further comprises, when the wireless communication device does not detect a DCI that uses the particular DCI format and either: (a) a semi-static Time Division Duplexing (TDD) configuration received by the wireless communication device indicates the set of symbols configured for the one or more configured transmissions as flexible or (b) the wireless communication device did not receive a semi-static TDD configuration, making a determination of whether the one or more configured transmissions are allowed to be transmitted or are received based on whether a parameter is configured. In this manner, configured uplink or downlink transmissions are controlled in a flexible manner that enables robust operation in various operating environments.

In one embodiment, the set of symbols is a set of symbols in a slot.

In one embodiment, making the determination comprises making the determination when the when the wireless communication device does not detect a DCI that uses the particular DCI format and provides a slot format for the slot and either: (a) a semi-static TDD configuration received by the wireless communication device indicates the set of symbols configured for the one or more configured transmissions as flexible or (b) the wireless communication device did not receive a semi-static TDD configuration.

In one embodiment, the method further comprises receiving, from the base station, a configuration for monitoring the particular DCI format. In one embodiment, the one or more configured transmissions are one or more configured uplink transmissions, and making the determination comprises making the determination of whether the one or more configured uplink transmissions are allowed to be transmitted based on whether the parameter is configured. In one embodiment, the method further comprises either transmitting or refraining from transmitting the one or more configured uplink transmissions on the configured set of symbols for the one or more configured uplink transmissions in accordance with the determination. In one embodiment, the one or more configured uplink transmissions comprise a physical uplink control channel (PUCCH) transmission, a physical uplink shared channel (PUSCH) transmission, a physical random access channel (PRACH) transmission, or a sounding reference signal (SRS) transmission.

In one embodiment, the one or more configured transmissions are one or more configured downlink transmissions, and making the determination comprises making the determination of whether the one or more configured downlink transmissions are received based on whether the parameter is configured. In one embodiment, the method further comprises either receiving or refraining from receiving the one or more configured downlink transmissions on the configured set of symbols for the one or more configured downlink transmissions in accordance with the determination. In one embodiment, the one or more configured downlink transmissions comprise a physical downlink shared channel (PDSCH) transmission or a channel state information reference signal (CSI-RS) transmission.

In one embodiment, the particular DCI format is DCI format 2_0. In another embodiment, the particular DCI format is a DCI format that comprises a slot format indicator.

In one embodiment, the wireless communication device does not detect a DCI that uses the particular DCI format by a particular amount of time before a start of a set of symbols configured for the one or more configured transmissions. In one embodiment, the particular amount of time is a physical uplink channel processing delay of the wireless communication device.

In one embodiment, the method further comprises receiving a configuration of the parameter, wherein making the determination of whether the one or more configured transmissions are allowed to be transmitted or are received based on whether the parameter is configured comprises making a determination that the one or more configured transmissions are allowed to be transmitted or are received based on receiving the configuration of the parameter.

In one embodiment, the parameter is a Radio Resource Control (RRC) parameter.

In one embodiment, the method further comprises receiving information that indicates whether configured uplink transmissions are allowed within a particular Channel Occupancy Time (COT) duration, making a determination of whether configured uplink transmissions are allowed within the particular COT duration based on the information, and performing one or more actions based on the determination as to whether configured uplink transmissions are allowed within the particular COT duration. In one embodiment, the determination of whether configured uplink transmissions are allowed within the particular COT duration overrides the determination of whether the one or more configured uplink transmissions are allowed to be transmitted or are received based on whether the parameter is configured.

In one embodiment, the determination is of whether all configured transmissions are allowed to be transmitted or are received. In another embodiment, the determination is of whether a particular subset of configured transmissions is allowed to be transmitted or are received. In one embodiment, the determination is of whether one or more particular types of configured transmissions are allowed to be transmitted or are received.

In one embodiment, a configuration of the parameter comprises a configuration of one or more specific time periods when the parameter is or is not applicable. In another embodiment, a configuration of the parameter comprises different values for the parameter for different time durations or different time periods. In another embodiment, a configuration of the parameter comprises a configuration of one or more specific carriers for which the parameter is applicable. In another embodiment, a configuration of the parameter comprises a configuration of one or more specific signals for which the parameter is applicable, a configuration of one or more channels for which the parameter is applicable, or both a configuration of one or more specific signals for which the parameter is applicable and a configuration of one or more channels for which the parameter is applicable. In another embodiment, a configuration of the parameter comprises different values for the parameter for different types of transmissions. In another embodiment, a configuration of the parameter comprises different values for the parameter for different Listen Before Talk (LBT) bandwidths. In another embodiment, a configuration of the parameter comprises different values for the parameter for licensed and unlicensed spectrum.

Corresponding embodiments of a wireless communication device are also disclosed. In one embodiment, a wireless communication device is adapted to receive, from a base station, a configuration of a set of symbols for one or more configured transmissions and monitoring for a DCI that uses a particular DCI format. The wireless communication device is further adapted to, when the wireless communication device does not detect a DCI that uses the particular DCI format and either: (a) a semi-static TDD configuration received by the wireless communication device indicates the set of symbols configured for the one or more configured transmissions as flexible or (b) the wireless communication device did not receive a semi-static TDD configuration, make a determination of whether the one or more configured transmissions are allowed to be transmitted or are received based on whether a parameter is configured.

In one embodiment, a wireless communication device comprises one or more transmitters, one or more receivers, and processing circuitry associated with the one or more transmitters and the one or more receivers. The processing circuitry is configured to cause the wireless communication device to receive, from a base station, a configuration of a set of symbols for one or more configured transmissions and monitoring for a DCI that uses a particular DCI format. The processing circuitry is further configured to cause the wireless communication device, when the wireless communication device does not detect a DCI that uses the particular DCI format and either: (a) a semi-static TDD configuration received by the wireless communication device indicates the set of symbols configured for the one or more configured transmissions as flexible or (b) the wireless communication device did not receive a semi-static TDD configuration, make a determination of whether the one or more configured transmissions are allowed to be transmitted or are received based on whether a parameter is configured.

In another embodiment, a method performed by a wireless communication device comprises receiving, from a base station, information that indicates whether configured uplink transmissions are allowed within a particular COT duration and making a determination as to whether configured uplink transmissions are allowed within the particular COT duration based on the information. The method further comprises performing one or more actions based on the determination as to whether configured uplink transmissions are allowed.

In one embodiment, the configured uplink transmissions comprise a PUCCH transmission, a PUSCH transmission, a PRACH transmission, or a SRS transmission.

In one embodiment, receiving the information that indicates whether configured uplink transmissions are allowed within the particular COT duration comprises receiving a DCI message comprising the information that indicates whether configured uplink transmissions are allowed within the particular COT duration. In one embodiment, the DCI message is in a particular DCI format. In one embodiment, the information that indicates whether configured uplink transmissions are allowed within the particular COT duration is 1-bit comprised in a particular field of the DCI message. In one embodiment, the articular field is a 1-bit CUL Indicator field of the DCI message.

In one embodiment, the information that indicates whether configured uplink transmissions are allowed within the particular COT duration indicates whether all configured uplink transmissions are allowed within the particular COT duration. In another embodiment, the information that indicates whether configured uplink transmissions are allowed within the particular COT duration indicates whether a particular subset of configured uplink transmissions are allowed within the particular COT duration. In another embodiment, the information that indicates whether configured uplink transmissions are allowed within the particular COT duration indicates whether one or more particular types of configured uplink transmissions are allowed within the particular COT duration. In another embodiment, the information that indicates whether configured uplink transmissions are allowed within the particular COT duration comprises a plurality of bits, and each bit of the plurality of bits indicates whether a respective type of a plurality of configured uplink transmissions types is allowed within the particular COT duration.

Corresponding embodiments of a wireless communication device are also disclosed. In one embodiment, a wireless communication device is adapted to receive, from a base station, information that indicates whether configured uplink transmissions are allowed within a particular COT duration and make a determination as to whether configured uplink transmissions are allowed within the particular COT duration based on the information. The wireless communication device is further adapted to perform one or more actions based on the determination as to whether configured uplink transmissions are allowed.

In one embodiment, a wireless communication device comprises one or more transmitters, one or more receivers, and processing circuitry associated with the one or more transmitters and the one or more receivers. The processing circuitry is configured to cause the wireless communication device to receive, from a base station, information that indicates whether configured uplink transmissions are allowed within a particular COT duration and make a determination as to whether configured uplink transmissions are allowed within the particular COT duration based on the information. The processing circuitry is further configured to cause the wireless communication device to perform one or more actions based on the determination as to whether configured uplink transmissions are allowed.

In another embodiment, a method performed by a wireless communication device comprises receiving, from the base station, a configuration of a set of symbols for one or more configured uplink transmissions and receiving, from the base station, a configuration for monitoring a particular DCI format. The method further comprises monitoring for a DCI that uses that particular DCI format. The method further comprises, when the wireless communication device does not detect a DCI that uses the particular DCI format and either: (a) a semi-static TDD configuration received by the wireless communication device indicates the set of symbols configured for the one or more configured uplink transmissions as flexible or (b) the wireless communication device did not receive a semi-static TDD configuration, making a determination as to whether the one or more configured uplink transmissions are allowed based on whether the wireless communication device is operating in a licensed frequency band and operating in accordance with the determination.

In one embodiment, the one or more configured uplink transmissions comprise a PUCCH transmission, a PUSCH transmission, a PRACH transmission, or a SRS transmission.

In one embodiment, the particular DCI format is New Radio (NR) DCI format 2_0.

In one embodiment, the method further comprises receiving information that indicates whether configured uplink transmissions are allowed within a particular COT duration, making a determination as to whether configured uplink transmissions are allowed within the particular COT duration based on the information, and performing one or more actions based on the determination as to whether configured uplink transmissions are allowed within the particular COT duration. In one embodiment, the determination as to whether configured uplink transmissions are allowed within the particular COT duration overrides the determination as whether the one or more configured uplink transmissions are allowed based on whether the wireless communication device is operating in a licensed frequency band.

In one embodiment, the determination is of whether all configured uplink transmissions are allowed. In another embodiment, the determination is of whether a particular subset of configured uplink transmissions are allowed. In another embodiment, the determination is of whether one or more particular types of configured uplink transmissions are allowed.

Corresponding embodiments of a wireless communication device are also disclosed. In one embodiment, a wireless communication device is adapted to receive, from a base station, a configuration of a set of symbols for one or more configured uplink transmissions and receive, from the base station, a configuration for monitoring a particular DCI format. The wireless communication device is further adapted to monitor for a DCI that uses that particular DCI format. The wireless communication device is further adapted to, when the wireless communication device does not detect a DCI that uses the particular DCI format and either: (a) a semi-static TDD configuration received by the wireless communication device indicates the set of symbols configured for the one or more configured uplink transmissions as flexible or (b) the wireless communication device did not receive a semi-static TDD configuration, make a determination as to whether the one or more configured uplink transmissions are allowed based on whether the wireless communication device is operating in a licensed frequency band and operate in accordance with the determination.

In one embodiment, a wireless communication device comprises one or more transmitters, one or more receivers, and processing circuitry associated with the one or more transmitters and the one or more receivers. The processing circuitry is configured to cause the wireless communication device to receive, from a base station, a configuration of a set of symbols for one or more configured uplink transmissions and receive, from the base station, a configuration for monitoring a particular DCI format. The processing circuitry is further configured to cause the wireless communication device to monitor for a DCI that uses that particular DCI format. The processing circuitry is further configured to cause the wireless communication device to, when the wireless communication device does not detect a DCI that uses the particular DCI format and either: (a) a semi-static TDD configuration received by the wireless communication device indicates the set of symbols configured for the one or more configured uplink transmissions as flexible or (b) the wireless communication device did not receive a semi-static TDD configuration, make a determination as to whether the one or more configured uplink transmissions are allowed based on whether the wireless communication device is operating in a licensed frequency band and operate in accordance with the determination.

Embodiments of a method performed by a network node are also disclosed. In one embodiment, a method performed by a network node that implements at least some functionality of a base station for a cellular communications system comprises transmitting or initiating transmission of, to a wireless communication device, a configuration of a set of symbols for one or more configured transmissions. The method further comprises transmitting or initiating transmission of, to the wireless communication device, a configuration for monitoring a particular DCI format. The method further comprises transmitting or initiating transmission of, to the wireless communication device, a parameter that indicates that one or more configured transmissions are allowed to be transmitted or are to be received by the wireless communication device when the wireless communication device does not detect a DCI that uses the particular DCI format and either: (a) a semi-static TDD configuration received by the wireless communication device indicates the set of symbols configured for the one or more configured transmissions as flexible or (b) the wireless communication device did not receive a semi-static TDD configuration.

In one embodiment, the one or more configured transmissions are one or more configured uplink transmissions. In one embodiment, the one or more configured uplink transmissions comprise a PUCCH transmission, a PUSCH transmission, a PRACH transmission, or a SRS transmission.

In one embodiment, the one or more configured transmissions are one or more configured downlink transmissions. In one embodiment, the one or more configured downlink transmissions comprise a PDSCH transmission or a CSI-RS transmission.

In one embodiment, the particular DCI format is DCI format 2_0. In another embodiment, the particular DCI format is a DCI format that comprises a slot format indicator.

Corresponding embodiments of a network node are also disclosed. In one embodiment, a network node that implements at least some functionality of a base station for a cellular communications system is adapted to transmit or initiate transmission of, to a wireless communication device, a configuration of a set of symbols for one or more configured transmissions and transmit or initiate transmission of, to the wireless communication device, a configuration for monitoring a particular DCI format. The network node is further adapted to transmit or initiate transmission of, to the wireless communication device, a parameter that indicates that one or more configured transmissions are allowed to be transmitted or are to be received by the wireless communication device when the wireless communication device does not detect a DCI that uses the particular DCI format and either: (a) a semi-static TDD configuration received by the wireless communication device indicates the set of symbols configured for the one or more configured transmissions as flexible or (b) the wireless communication device did not receive a semi-static TDD configuration.

In one embodiment, a network node that implements at least some functionality of a base station for a cellular communications system comprises processing circuitry configured to cause the network node to transmit or initiate transmission of, to a wireless communication device, a configuration of a set of symbols for one or more configured transmissions and transmit or initiate transmission of, to the wireless communication device, a configuration for monitoring a particular DCI format. The processing circuitry is further configured to cause the network node to transmit or initiate transmission of, to the wireless communication device, a parameter that indicates that one or more configured transmissions are allowed to be transmitted or are to be received by the wireless communication device when the wireless communication device does not detect a DCI that uses the particular DCI format and either: (a) a semi-static TDD configuration received by the wireless communication device indicates the set of symbols configured for the one or more configured transmissions as flexible or (b) the wireless communication device did not receive a semi-static TDD configuration.

In one embodiment, a method performed by a network node that implements at least some functionality of a base station for a cellular communications system comprises transmitting or initiating transmission of, to a wireless communication device, information that indicates whether configured uplink transmissions are allowed within a particular COT duration.

In one embodiment, the configured uplink transmissions comprise a PUCCH transmission, a PUSCH transmission, a PRACH transmission, or a SRS transmission.

In one embodiment, transmitting or initiating transmission of the information that indicates whether configured uplink transmissions are allowed within the particular COT duration comprises transmitting or initiating transmission of a DCI message comprising the information that indicates whether configured uplink transmissions are allowed within the particular COT duration. In one embodiment, the DCI message is in a particular DCI format. In one embodiment, the information that indicates whether configured uplink transmissions are allowed within the particular COT duration is 1-bit comprised in a particular field of the DCI message. In one embodiment, the particular field is a 1-bit CUL Indicator field of the DCI message.

In one embodiment, the information that indicates whether configured uplink transmissions are allowed within the particular COT duration indicates whether all configured uplink transmissions are allowed within the particular COT duration. In one embodiment, the information that indicates whether configured uplink transmissions are allowed within the particular COT duration indicates whether a particular subset of configured uplink transmissions are allowed within the particular COT duration. In one embodiment, the information that indicates whether configured uplink transmissions are allowed within the particular COT duration indicates whether one or more particular types of configured uplink transmissions are allowed within the particular COT duration. In one embodiment, the information that indicates whether configured uplink transmissions are allowed within the particular COT duration comprises a plurality of bits, and each bit of the plurality of bits indicates whether a respective type of a plurality of configured uplink transmissions types is allowed within the particular COT duration.

Corresponding embodiments of a network node are also disclosed. In one embodiment, a network node that implements at least some functionality of a base station for a cellular communications system is adapted to transmit or initiate transmission of, to a wireless communication device, information that indicates whether configured uplink transmissions are allowed within a particular COT duration.

In one embodiment, a network node that implements at least some functionality of a base station for a cellular communications system comprises processing circuitry configured to cause the network node to transmit or initiate transmission of, to a wireless communication device, information that indicates whether configured uplink transmissions are allowed within a particular COT duration.

In one embodiment, a method performed by a network node that implements at least some functionality of a base station for a cellular communications system comprises transmitting or initiating transmission of, to a wireless communication device, a configuration of a set of symbols for one or more configured uplink transmissions and transmitting or initiating transmission of, to the wireless communication device, a configuration for monitoring a particular DCI format. The method further comprises, when the wireless communication device does not detect a DCI that uses the particular DCI format and either: (a) a semi-static TDD configuration received by the wireless communication device indicates the set of symbols configured for the one or more configured uplink transmissions as flexible or (b) the wireless communication device did not receive a semi-static TDD configuration, whether the one or more configured uplink transmissions are allowed is based on whether the wireless communication device is operating in a licensed frequency band.

In one embodiment, the one or more configured uplink transmissions comprise a PUCCH transmission, a PUSCH transmission, a PRACH transmission, or a SRS transmission.

In one embodiment, the particular DCI format is NR DCI format 2_0.

Corresponding embodiments of a network node are also disclosed. In one embodiment, a network node that implements at least some functionality of a base station for a cellular communications system is adapted to transmit or initiate transmission of, to a wireless communication device, a configuration of a set of symbols for one or more configured uplink transmissions and transmit or initiate transmission of, to the wireless communication device, a configuration for monitoring a particular DCI format. The network node is further adapted to, when the wireless communication device does not detect a DCI that uses the particular DCI format and either: (a) a semi-static TDD configuration received by the wireless communication device indicates the set of symbols configured for the one or more configured uplink transmissions as flexible or (b) the wireless communication device did not receive a semi-static TDD configuration, whether the one or more configured uplink transmissions are allowed is based on whether the wireless communication device is operating in a licensed frequency band.

In one embodiment, a network node that implements at least some functionality of a base station for a cellular communications system comprises processing circuitry configured to cause the network node to transmit or initiate transmission of, to a wireless communication device, a configuration of a set of symbols for one or more configured uplink transmissions and transmit or initiate transmission of, to the wireless communication device, a configuration for monitoring a particular DCI format. The processing circuitry is further configured to cause the network node to, when the wireless communication device does not detect a DCI that uses the particular DCI format and either: (a) a semi-static TDD configuration received by the wireless communication device indicates the set of symbols configured for the one or more configured uplink transmissions as flexible or (b) the wireless communication device did not receive a semi-static TDD configuration, whether the one or more configured uplink transmissions are allowed is based on whether the wireless communication device is operating in a licensed frequency band.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the basic New Radio (NR) physical resource over an antenna port;

FIG. 2 shows a few exemplary cell-specific Time Division Duplexing (TDD) patterns that can be configured semi-statically by TDD-UL-DL-ConfigCommon in NR Release 15;

FIG. 3 illustrates one example of a cellular communications system in which embodiments of the present disclosure may be implemented;

FIG. 4 is a flow chart that illustrates the use of a parameter controlling whether uplink transmissions configured by higher layers are allowed in accordance with an embodiment of the present disclosure;

FIG. 5 illustrates the operation of a wireless communication device (e.g., a User Equipment (UE)) and a base station (e.g., a NR base station (gNB)) in accordance with an embodiment of the present disclosure;

FIG. 6 is a flow chart that illustrates steps 510 and 512 of FIG. 5 in more detail in accordance with one example embodiment of the present disclosure;

FIG. 7 is a flow chart that illustrates the use of a parameter controlling whether downlink transmissions configured by higher layers are allowed in accordance with an embodiment of the present disclosure;

FIG. 8 illustrates the operation of a wireless communication device (e.g., a UE) and a base station (e.g., a gNB) in which a parameter controlling whether downlink transmissions configured by higher layers are allowed is used in accordance with an embodiment of the present disclosure;

FIG. 9 is a flow chart that illustrates steps 810 and 812 of FIG. 8 in more detail in accordance with one example embodiment of the present disclosure;

FIG. 10 illustrates the operation of a wireless communication device (e.g., a UE) and a base station (e.g., a gNB) in accordance with another embodiment of the present disclosure;

FIG. 11 illustrates a process for controlling whether uplink transmissions configured by higher layers are allowed based on whether a parameter is configured in accordance with another embodiment of the present disclosure;

FIG. 12 illustrates a process for controlling whether uplink transmissions configured by higher layers are allowed based on whether a parameter is configured in accordance with another embodiment of the present disclosure;

FIG. 13 illustrates a process for controlling whether downlink transmissions configured by higher layers are allowed based on whether a parameter is configured in accordance with another embodiment of the present disclosure;

FIG. 14 illustrates the operation of a wireless communication device (e.g., a UE) and a base station (e.g., a gNB) to control whether configured transmissions are allowed in accordance with another embodiment of the present disclosure;

FIG. 15 illustrates the operation of a wireless communication device (e.g., a UE) and a base station (e.g., a gNB) to control whether configured transmissions are allowed based on whether the transmission is in an unlicensed frequency band in accordance with another embodiment of the present disclosure;

FIGS. 16 through 18 are schematic block diagrams of example embodiments of a network node;

FIGS. 19 and 20 are schematic block diagrams of example embodiments of a wireless device;

FIG. 21 illustrates an example embodiment of a communication system in which embodiments of the present disclosure may be implemented;

FIG. 22 illustrates example embodiments of the host computer, base station, and UE of FIG. 21;

FIGS. 23 through 26 are flow charts that illustrate example embodiments of methods implemented in a communication system such as that of FIG. 21.

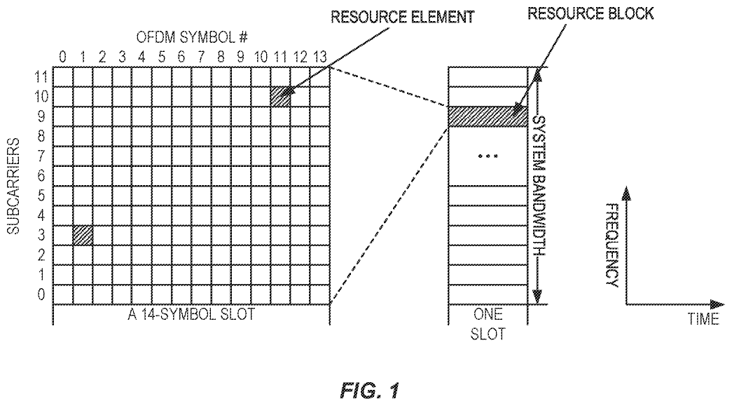

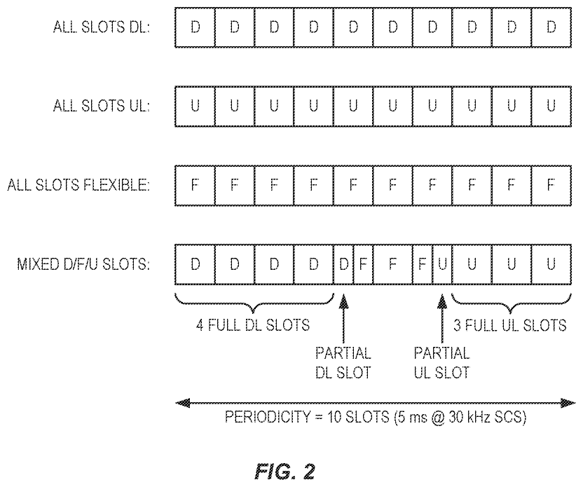

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Function (AMF), a UPF, a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s) in relation to configured uplink (UL) transmissions. Existing solutions for configured uplink transmissions have one or more of the following problems:
If configured UL transmissions are to be allowed without any dynamic trigger messages on the downlink (DL), configuring Group Common PDCCH (GC-PDCCH) for monitoring for DCI using DCI format 2_0 is severely limited. This prevents the provision of slot format information and other information such as Listen Before Talk (LBT) type to be employed by the UE.
If DCI format 2_0 is configured and the UE detects a DCI using DCI format 2_0, thus requiring control of configured UL transmissions by indication of ‘U’ in a DCI 2_0 message, this creates unnecessary congestion on the carrier. In order to avoid impact on latency, frequent DL transmissions carrying a DCI format 2_0 message are required even when there is no DL data to send.
If DCI format 2_0 is configured and the UE detects DCI using DCI format 2_0, thus requiring control of configured UL transmissions by indication of ‘U’ in a DCI 2_0 message, and the DCI 2_0 message transmissions are not performed frequently, this causes severe degradation in UL throughput due to large delays in sending information such as scheduling requests (SRs) or large delays in configured grant Physical Uplink Shared Channel (PUSCH) transmissions.

Certain aspects of the present disclosure and their embodiments may provide solutions to the aforementioned or other challenges. In some embodiments, the solutions disclosed herein include one or more of the following:
For the case when the UE is configured to receive GC-PDCCH (Scenarios A-1 and A-2) and the GC-PDCCH is not detected by the UE, the configuration of a parameter via higher layer signaling (e.g., Radio Resource Control (RRC) signaling) is provided, where the parameter determines whether configured UL transmissions are allowed or not in symbols which are indicated as being flexible (‘F’) by a semi-static TDD configuration or for which no indication of transmit direction is received.
The configuration of specific time periods where the above parameter is or is not applicable.
The configuration of specific carriers for which the above parameter is applicable.
The configuration of specific UL signals and/or channels for which the above parameter is applicable.

Certain embodiments may provide one or more of the following technical advantage(s). Embodiments of the solutions proposed herein may solve some or all of the problems with existing solutions discussed above and may allow operation in a wide variety of environments with robust system performance.

Embodiments of a method of operation of a wireless communication device (e.g., a UE) and corresponding embodiments of a wireless communication device are disclosed herein. In some embodiments, when the wireless communication device is configured to receive GC-PDCCH (e.g., Scenarios A-1 and A-2) and the GC-PDCCH is not detected by the wireless communication device, a parameter is configured via higher layer signaling (e.g., RRC signaling), where the parameter determines whether configured UL transmissions are allowed or not in symbols which are indicated as being flexible (‘F’) by a semi-static TDD configuration or for which no indication of transmit direction is received. In some embodiments, the wireless communication device performs one or more operational tasks based on this parameter (e.g., transmits one or more configured UL transmissions or refrains from transmitting one or more UL configured transmissions, in accordance with the parameter). In some embodiments, the wireless communication device receives a configuration of specific time periods where the above parameter is or is not applicable. In some embodiments, the wireless communication device receives a configuration of specific carriers for which the above parameter is applicable. In some embodiments, the wireless communication device receives a configuration of specific UL signals and/or channels for which the above parameter is applicable.

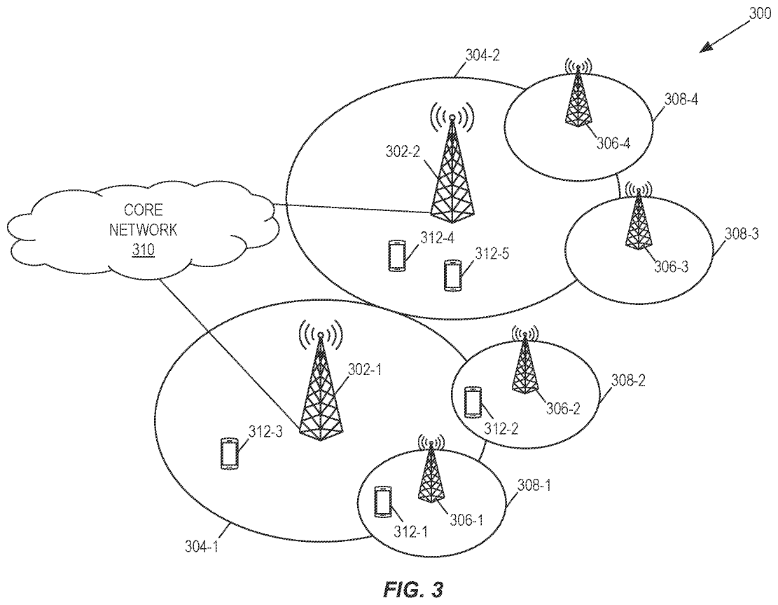

FIG. 3 illustrates one example of a cellular communications system 300 in which embodiments of the present disclosure may be implemented. In the embodiments described herein, the cellular communications system 300 is a 5G system (5GS) including a Next Generation RAN (NG-RAN) (also referred to herein as a NR RAN). In this example, the RAN includes base stations 302-1 and 302-2, which in 5G NR are referred to as gNBs or ng-eNBs (LTE RAN nodes connected to 5GC), controlling corresponding (macro) cells 304-1 and 304-2. The base stations 302-1 and 302-2 are generally referred to herein collectively as base stations 302 and individually as base station 302. Likewise, the (macro) cells 304-1 and 304-2 are generally referred to herein collectively as (macro) cells 304 and individually as (macro) cell 304. The RAN may also include a number of low power nodes 306-1 through 306-4 controlling corresponding small cells 308-1 through 308-4. The low power nodes 306-1 through 306-4 can be small base stations (such as pico or femto base stations) or Remote Radio Heads (RRHs), or the like. Notably, while not illustrated, one or more of the small cells 308-1 through 308-4 may alternatively be provided by the base stations 302. The low power nodes 306-1 through 306-4 are generally referred to herein collectively as low power nodes 306 and individually as low power node 306. Likewise, the small cells 308-1 through 308-4 are generally referred to herein collectively as small cells 308 and individually as small cell 308. The cellular communications system 300 also includes a core network 310, which in the 5GS is referred to as the 5G core (5GC). The base stations 302 (and optionally the low power nodes 306) are connected to the core network 310.

The base stations 302 and the low power nodes 306 provide service to wireless communication devices 312-1 through 312-5 in the corresponding cells 304 and 308. The wireless communication devices 312-1 through 312-5 are generally referred to herein collectively as wireless communication devices 312 and individually as wireless communication device 312. In the following description, the wireless communication devices 312 are oftentimes UEs, but the present disclosure is not limited thereto.

Now, a description of some example embodiments of the present disclosure is provided. Note that while some of these embodiments are described under separate headings, these embodiments may be combined. Further, these embodiments are described with respect to a UE and gNB; however, the embodiments are more generally applicable to a wireless communication device 312 (e.g., a UE) and a network node that implements at least some functionality of a base station (e.g., at least some functionality of a gNB).

### Embodiment #1

For the case when the UE is configured to monitor for a GC-PDCCH (Scenarios A-1 and A-2) and the GC-PDCCH message is not detected by the UE, a parameter is used to control whether UL transmissions are allowed in symbols which are indicated as being flexible by a semi-static TDD configuration or for which no indication is provided. In this embodiment, the parameter may be a single bit that indicates whether such UL transmissions are allowed or not.

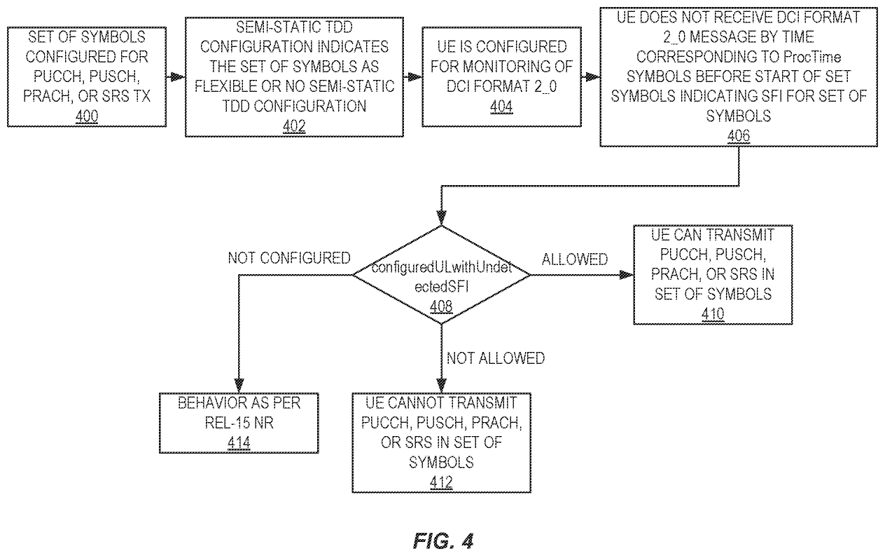

A non-limiting example of how such a parameter, referred to in this example as configuredULwithUndetectecISFI, may be used in the UE procedure for controlling UL transmissions configured by higher layers is shown in FIG. 4. FIG. 4 is a flow chart that illustrates the use of a parameter controlling whether UL transmissions configured by higher layers are allowed. The behavior for cases not shown in FIG. 4 may, e.g., be as defined in Rel-15 NR specifications.

As illustrated in FIG. 4, the UE is configured (e.g., by a base station) with a set of symbols for configured UL transmissions (e.g., PUCCH, PUSCH, PRACH, or SRS transmissions, in this example) (step 400). The UE may also be configured (e.g., by a base station) with a semi-static TDD configuration that indicates the set of symbols as flexible or the UE may not be configured with a semi-static TDD configuration (step 402). The UE is also configured (e.g., by a base station) for monitoring of DCI Format 2_0 (step 404). The UE monitors for a DCI Format 2_0 message and does not receive a DCI Format 2_0 message by a time corresponding to ProcTime symbols (e.g., the PUSCH preparation time) before the start of a set of symbols indicating SFI for the set of symbols (step 406).

In step 408, the UE determines whether it has been configured (e.g., via higher layer signaling such as, e.g., RRC signaling) with a parameter (configuredULwithUndetectecISFI) that controls whether the UE is allowed to transmit configured UL transmissions in symbols that are indicated as being flexible (‘F’) by a semi-static TDD configuration or for which no indication of transmit direction is received. If the configuredULwithUndetectecISFI has been configured for the UE, the UE determines whether configuredULwithUndetectedSFI indicates that such configured UL transmissions are allowed or not allowed. If configuredULwithUndetectedSFI indicates that such configured UL transmissions are allowed, the UE determines that the configured UL transmissions are allowed on the set of symbols (step 410). In other words, the UE transmits the configured UL transmissions on the set of symbols. Conversely, if configuredULwithUndetectedSFI indicates that such configured UL transmissions are not allowed, the UE determines that the configured UL transmissions are not allowed on the set of symbols (step 412). As such, the UE refrains from transmitting the configured UL transmissions on the set of symbols.

Returning to step 408, if the parameter configuredULwithUndetectedSFI has not been configured for the UE, the UE may operate in accordance with default behavior (e.g., in accordance with Rel-15 NR specifications) (step 414).

In some embodiments, the parameter (configuredULwithUndetectedSFI) may be signaled via higher layer RRC signaling or may be delivered by Medium Access Control (MAC) Control Element (CE). In another variation of this embodiment, the parameter (configuredULwithUndetectedSFI) itself may be signaled to UEs in a GC-PDCCH. In some embodiments, this option would only be used in environments where the reliability of such GC-PDCCH is very high.

An example description of the use of the above parameter (configuredULwithUndetectedSFI) in the relevant part of the NR specifications (3GPP TS 38.213, Section 11.1.1) is given below. Underlining is used to highlight relevant aspects.

```
For a set of symbols of a slot that are indicated as flexible by tdd-UL-DL-ConfigurationCommon,
and tdd-UL-DL-ConfigurationDedicated if provided, or when tdd-UL-DL-
ConfigurationCommon, and tdd-UL-DL-ConfigurationDedicated are not provided to the UE, and
if the UE does not detect a DCI format 2_0 providing a slot format for the slot
  - the UE receives PDSCH or CSI-RS in the set of symbols of the slot if the UE receives a
  corresponding indication by a DCI format 1_0, DCI format 1_1, or DCI format 0_1
  - the UE transmits PUSCH, PUCCH, PRACH, or SRS in the set of symbols of the slot if
  the UE receives a corresponding indication by a DCI format 0_0, DCI format 0_1, DCI
  format 1_0, DCI format 1_1, or DCI format 2_3
  - the UE receives PDCCH as described in Subclause 10.1
  - if the UE is configured by higher layers to receive PDSCH or CSI-RS in the set of
  symbols of the slot, the UE does not receive the PDSCH or the CSI-RS in the set of
  symbols of the slot
  - if the UE is configured by higher layers to transmit SRS, or PUCCH, or PUSCH, or
  PRACH in the set of symbols of the slot, and the UE is not configured with higher layer
  parameter configuredULwithUndetectedSFI,
```

| | |
|---|---|
| - | does not transmit the PUCCH, or the PUSCH, or the PRACH in the slot and does not |
| | transmit the SRS in symbols from the set of symbols in the slot, if any, starting from a |
| | symbol that is after PUSCH preparation time T_{proc,2} for the corresponding PUSCH timing |
| | capability [6, TS 38.214] assuming d_{2,1} = 1 after a last symbol of a CORESET where the |
| | UE is configured to monitor PDCCH for DCI format 2_0 and μ corresponds to the |
| | smallest SCS configuration between the SCS configuration of the PDCCH carrying the |
| | DCI format 2_0 and the SCS configuration of the SRS, PUCCH, PUSCH or μᵣ, where μᵣ |
| | corresponds to the SCS configuration of the PRACH if it is 15kHz or higher; otherwise |
| | μᵣ=0 |
| - | does not expect to cancel the transmission of the SRS, or the PUCCH, or the PUSCH, or |
| | the PRACH in symbols from the set of symbols in the slot, if any, starting before a |
| | symbol that is after the PUSCH preparation time T_{proc,2} for the corresponding PUSCH |
| | timing capability [6, TS 38.214] assuming d_{2,1} = 1 after a last symbol of a CORESET |
| | where the UE is configured to monitor PDCCH for DCI format 2_0 and μ corresponds |
| | to the smallest SCS configuration between the SCS configuration of the PDCCH |
| | carrying the DCI format 2_0 and the SCS configuration of the SRS, PUCCH, PUSCH or |
| | μᵣ, where μᵣ corresponds to the SCS configuration of the PRACH if it is 15kHz or |
| | higher; otherwise μᵣ=0 |

```
  - if the UE is configured by higher layers to transmit SRS, or PUCCH, or PUSCH, or
  PRACH in the set of symbols of the slot, and the UE is configured with higher layer
  parameter configuredULwithUndetectedSFI,
```

| | |
|---|---|
| - | does not transmit the PUCCH, or the PUSCH, or the PRACH |
| | in the slot and does not |
| | transmit the SRS in symbols from the set of symbols in the slot, if any, if |
| | configuredULwithUndetectedSFI is set to ‘0’ |
| - | does not expect to cancel the transmission of the SRS, |
| | or the PUCCH, or the PUSCH, or |
| | the PRACH in symbols from the set of symbols in the slot, if any, if |
| | configuredULwithUndetectedSFI is set to ‘1’ |

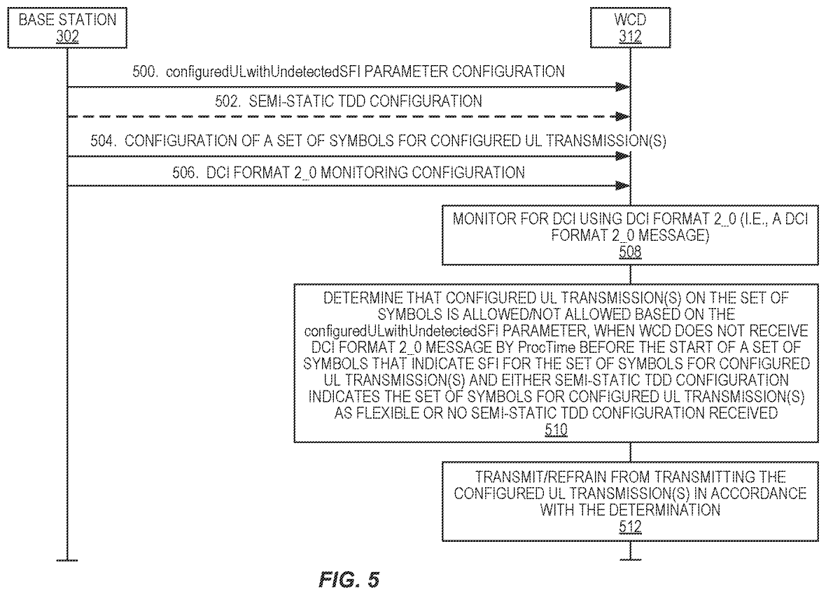

FIG. 5 illustrates the operation of a wireless communication device 312 (e.g., a UE) and a base station 302 (e.g., a gNB) in accordance with at least some aspects of the embodiments described above. Optional steps are represented by dashed lines or dashed boxes. Note that this process is only an example. It should also be noted that while the base station 302 (e.g., gNB) is illustrated as a single box or element, depending on the particular implementation, the base station 302 (e.g., gNB) may be implemented as a single network node or may be distributed across two or more network nodes. For example, the base station 302 may be implemented as two separate network nodes, namely, a first network node that implements, e.g., the PHY and at least a portion of the MAC layer and a second network node that implements higher layers and possibly at portion of the MAC layer. As a specific example, in the case of a gNB, the functionality of the gNB may be separated between a gNB Centralized Unit (gNB-CU) and one or more gNB Distributed Units (gNB-DUs). In this regard, steps or functions described herein as being performed by the base station 302 or gNB may be performed in a distributed manner. For example, a network node that implements the higher layer functionality may “initiate” transmission of a particular message (e.g., by sending the message to another network node that implements the lower layer(s)), thereby causing the other network node that implements the lower layer functionality to actually transmit the particular message.

As illustrated, the base station 302 sends, and the WCD 312 receives, a configuration of the configuredULwithUndetectedSFI parameter (step 500). As discussed above, in some embodiments, this configuration of the configuredULwithUndetectedSFI parameter may be higher layer signaling (e.g., RRC signaling) or lower layer signaling (e.g., a MAC CE). The base station 302 may also send, and the WCD 312 may also receive, a semi-static TDD configuration (step 502). The base station 302 sends, and the WCD 312 receives, a configuration of a set of symbols for configured UL transmission(s), as discussed above (step 504). The base station 302 sends, and the WCD 312 receives, a configuration for the WCD 312 to monitor for DCI Format 2_0 (step 506). Note that steps 500-506 may be performed in any desired order.

The WCD 312 monitors for DCI using DCI format 2_0 (i.e., monitors for a DCI Format 2_0 message or monitors for a DCI that is formatted in accordance with DCI Format 2_0) (step 508). When the WCD 312 does not receive a DCI Format 2_0 message by a time that corresponds to ProcTime (e.g., the PUSCH preparation time) before the start of a set of symbols that indicate a SFI for the set of symbols configured for the configured UL transmission(s) and either: (a) the semi-static TDD configuration received in step 502 indicates that the set of symbols configured for the configured UL transmission(s) are flexible (‘F’) or (b) the WCD 312 did not receive a semi-static TDD configuration, the WCD 312 determines that configured UL transmission(s) on the set of symbols configured for configured UL transmissions are allowed/not allowed based on the configuredULwithUndetectedSFI parameter, as described above (step 510). The WCD 312 then either transmits or refrains from transmitting the configured UL transmission(s) on the configured set of symbols in accordance with the determination made in step 510 (step 512).

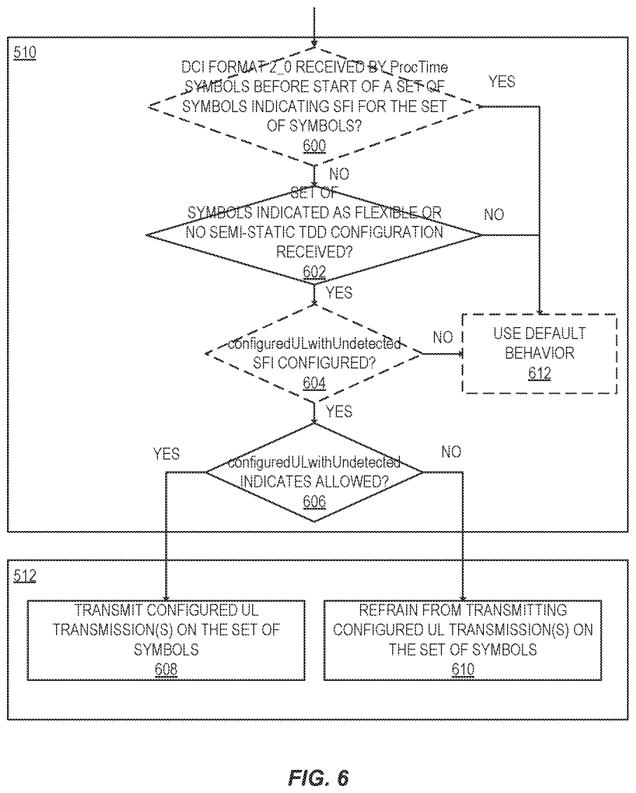

FIG. 6 is a flow chart that illustrates steps 510 and 512 in more detail in accordance with one example embodiment of the present disclosure. Again, optional steps are represented by dashed lines/boxes. As illustrated, the WCD 312 determines whether a DCI Format 2_0 message has been received by the WCD 312 by a time that corresponds to ProcTime (e.g., the PUSCH preparation time) before the start of a set of symbols that indicate a SFI for the set of symbols configured for the configured UL transmission(s) (step 600). If not, the WCD 312 determines whether the semi-static TDD configuration received in step 502 indicates that the set of symbols configured for the configured UL transmission(s) are flexible (‘F’) (if a semi-static TDD configuration was received) or the WCD 312 did not receive a semi-static TDD configuration (step 602). If either (a) the semi-static TDD configuration received in step 502 indicates that the set of symbols configured for the configured UL transmission(s) are flexible (‘F’) or (b) the WCD 312 did not receive a semi-static TDD configuration, the WCD 312 determines whether it was configured with the configuredULwithUndetectedSFI parameter (step 604). If so, the WCD 312 determines whether the configured configuredULwithUndetectecISFI parameter indicates that configured UL transmissions are allowed on the set of symbols configured for configured UL transmission(s) (step 606). If so, the WCD 312 transmits the configured UL transmission(s) on the configured set of symbols (step 608). If not, the WCD 312 refrains from transmitting the configured UL transmission(s) on the configured set of symbols (step 610).

Returning to steps 600, 602, and 604, if the WCD 312 did receive a DCI Format 2_0 before the time that corresponds to ProcTime (e.g., the PUSCH preparation time) before the start of the set of symbols that indicate a SFI for the set of symbols configured for the configured UL transmission(s) or if the set of symbols configured for the configured UL transmission(s) are not indicated as flexible in the semi-static TDD configuration (if a semi-static TDD configuration is received by the WCD 312) or if the WCD 312 is not configured with the configuredULwithUndetectecISFI parameter, the WCD 312 may, for example, operate in accordance with some predefined default behavior (e.g., as defined by Rel-15 NR specifications) (step 612).

### Embodiment #2

In this embodiment, the parameter (configuredULwithUndetectecISFI) disclosed in Embodiment #1 (e.g., as used in step 408 of FIG. 4 or as configured in step 500 of FIG. 5) may take different values for different time durations. In a non-limiting example, two periodically occurring time ranges may be defined. For example, the first one is defined within a range of slots spanning a 1-5 ms duration of time (referred to as a DRS transmission window) that occurs e.g. every 20, 40 or 80 ms. This duration of 1-ms coincides with potential transmissions of discovery reference signals (DRS) which are essential for accessing the system and performing neighbor cell measurements. The second one is defined outside of this range of slots. In this example, the parameter, configuredULwithUndetectecISFI may allow UL transmissions in resources configured by higher layers outside of the DRS transmission window but not allow them inside the window when a DCI format 2_0 is not detected. When a DCI format 2_0 is detected, UL transmissions may be permitted within the resources as per current Rel-15 specifications.

In another non-limiting example, multiple such periodically occurring ranges may be defined. The gNB may use these ranges to control the percentage of time that such configured UL transmissions are allowed depending on the load in the system.

An exemplary method to define different values for different time ranges is for configuredULwithUndetectedSFI to be defined as an information element that contains multiple fields each of which defines a time duration and a value indicating whether configured UL transmissions are allowed inside this time duration.

### Embodiment #3

In this embodiment, the parameter (configuredULwithUndetectecISFI) disclosed in Embodiment #1 may take different values for different types of UL transmissions. In a non-limiting example, separate fields may be defined for the PUSCH, PUCCH, PRACH, and SRS within the higher layer information element configuredULwithUndetectecISFI. Therefore, some types of UL transmissions may be allowed while some others may be disallowed.

This embodiment can also be used along with Embodiment #2 to control configured UL transmissions separately for different types of UL transmissions in different time durations.

### Embodiment #4

In this embodiment, the parameter (configuredULwithUndetectedSFI) disclosed in Embodiment #1 may take different values for different Listen Before Talk (LBT) bandwidths, where one or more LBT bandwidths are defined on one or more carriers operating in unlicensed spectrum. For example, if the LBT bandwidth is 20 MHz as it is for the 5 GHz unlicensed band, and a single 80 MHz carrier is configured, the parameter (configuredULwithUndetectedSFI) can take on 4 different values so that configured UL transmissions can be controlled separately per LBT bandwidth.

In one non-limiting example, the parameter (configuredULwithUndetectedSFI) can consist of a bitmap, where each bit in the bitmap corresponds to a different LBT bandwidth. The length of the bitmap depends on the number of carriers and the number of LBT bandwidths in each carrier.

As in the above embodiments, the bitmap may be signaled by, e.g., RRC, MAC-CE, or even in the GC-PDCCH message itself for high reliability environments.

### Embodiment #5

In this embodiment, the parameters and information elements disclosed in the previous embodiments may take different values when operating in licensed and unlicensed spectrum. Furthermore, whether configured UL transmissions are allowed or disallowed may depend on the type of sharing mechanism used on the carrier. For carriers where devices in the system operate as load based equipment (LBE) as per the ETSI BRAN harmonized standards (EN 301 893), the configuration of the parameters and information elements may be set differently than for carriers where the devices in the system operate as frame based equipment (FBE).

In another aspect of this embodiment, the parameters and information elements disclosed in the previous embodiments may be configured differently depending on the operating environment, e.g., the parameters may be set differently for small cells vs. macro cells, for low vs. high traffic loads and for environments with high interference vs. controlled environments with low interference.

### Embodiment #6

The above embodiments apply to the case where the UE is configured to monitor for a GC-PDCCH (Scenarios A-1 and A-2) and the GC-PDCCH message is not detected by the UE. The parameter (configuredULwithUndetectedSFI) disclosed in Embodiment #1 is used to control whether UL transmissions are allowed in symbols which are indicated as being flexible by a semi-static TDD configuration or for which no indication is provided.

In a variation of these embodiments that applies for the case when the UE is configured to monitor for a GC-PDCCH (Scenarios A-1 and A-2) and the GC-PDCCH message is detected by the UE, a new parameter is defined to control whether or not configured UL transmissions are cancelled for this case.

In Rel-15, if the symbols are indicated as flexible (‘F’) by the GC-PDCCH message, the configured UL transmissions are cancelled. In this embodiment, the new parameter, if not configured, maintains this behavior. However, if the parameter is configured, configured UL transmissions are allowed.

In a variation of this embodiment, configured UL transmissions are only allowed if a dedicated DCI message (e.g., DCI formats 1_1, 1_0) does not schedule a PDSCH or aperiodic CSI-RS transmission.

### Embodiment #7

In a variation of the above embodiments, a parameter is used to control whether DL transmissions are allowed in symbols which specified by all the conditioned explained in those embodiments.

For example, in a variation of Embodiment #1, the parameter controls whether DL transmissions are allowed in symbols which are indicated as being flexible by a semi-static TDD configuration or for which no indication is provided. In this embodiment, the parameter may be a single bit that indicates whether such DL transmissions are allowed or not.

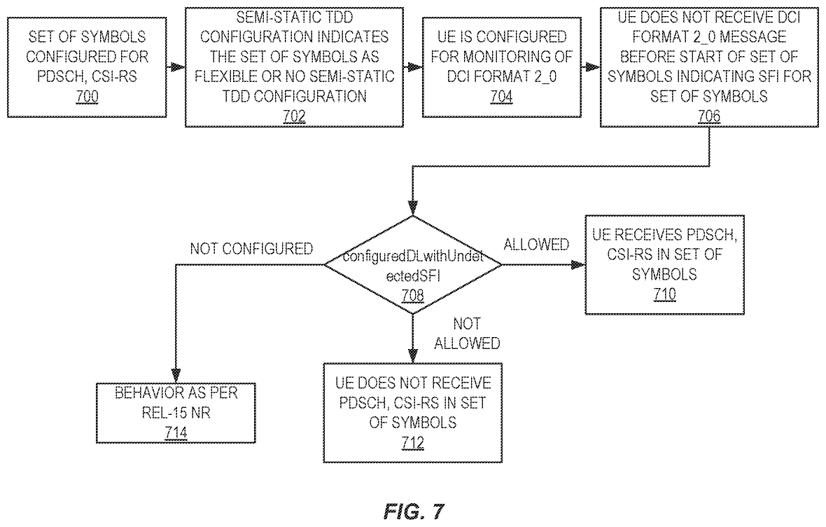

As a non-limiting example of how such a parameter, referred to as configuredDLwithUndetectedSFI in this example, may be used in the UE procedure for controlling DL transmissions configured by higher layers is shown in FIG. 7.

As illustrated in FIG. 7, the UE is configured (e.g., by a base station) with a set of symbols for configured DL transmissions (e.g., PDSCH or CSI-RS transmissions, in this example) (step 700). The UE may also be configured (e.g., by a base station) with a semi-static TDD configuration that indicates the set of symbols as flexible or the UE may not be configured with a semi-static TDD configuration (step 702). The UE is also configured (e.g., by a base station) for monitoring of DCI Format 2_0 (step 704). The UE monitors for a DCI Format 2_0 message and does not receive a DCI Format 2_0 message before the start of a set of symbols indicating SFI for the set of symbols (step 706).

In step 708, the UE determines whether it has been configured (e.g., via higher layer signaling such as, e.g., RRC signaling) with a parameter (configuredDLwithUndetectedSFI) that controls whether the UE is allowed to transmit configured DL transmissions in symbols that are indicated as being flexible (‘F’) by a semi-static TDD configuration or for which no indication of transmit direction is received. If the configuredDLwithUndetectedSFI has been configured for the UE, the UE determines whether configuredDLwithUndetectedSFI indicates that such configured DL transmissions are allowed or not allowed. If configuredDLwithUndetectedSFI indicates that such configured UL transmissions are allowed, the UE determines that the configured DL transmissions are allowed on the set of symbols (step 710). In other words, the UE receives the configured DL transmissions on the set of symbols. Conversely, if configuredDLwithUndetectedSFI indicates that such configured DL transmissions are not allowed, the UE determines that the configured DL transmissions are not allowed on the set of symbols (step 712). As such, the UE refrains from receiving the configured DL transmissions on the set of symbols.

Returning to step 708, if the parameter configuredDLwithUndetectedSFI has not been configured for the UE, the UE may operate in accordance with default behavior (e.g., in accordance with Rel-15 NR specifications) (step 714).

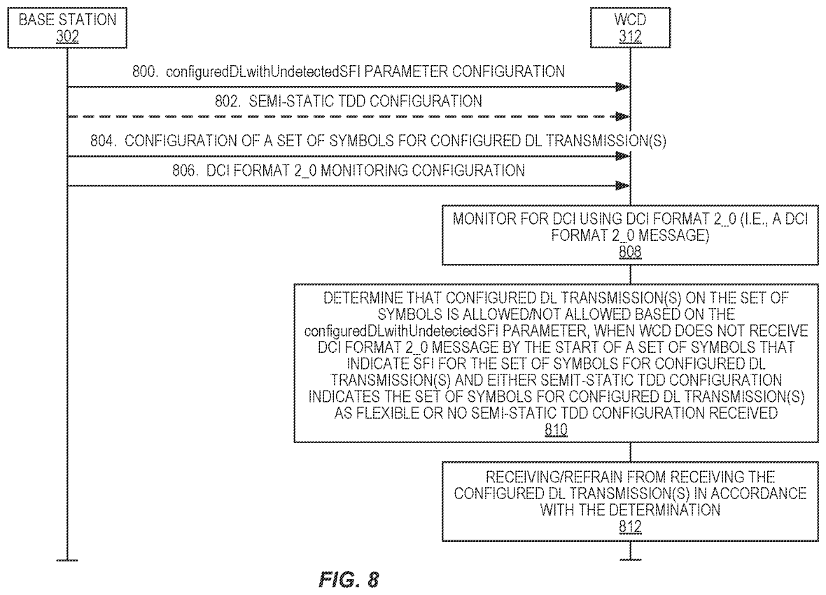

FIG. 8 illustrates the operation of a wireless communication device 312 (e.g., a UE) and a base station 302 (e.g., a gNB) in accordance with at least some aspects of the embodiments described above. Optional steps are represented by dashed lines or dashed boxes. Note that this process is only an example. It should also be noted that while the base station 302 (e.g., gNB) is illustrated as a single box or element, depending on the particular implementation, the base station 302 (e.g., gNB) may be implemented as a single network node or may be distributed across two or more network nodes. For example, the base station 302 may be implemented as two separate network nodes, namely, a first network node that implements e.g. the PHY and at least a portion of the MAC layer and a second network node that implements higher layers and possibly at portion of the MAC layer. As a specific example, in the case of a gNB, the functionality of the gNB may be separated between a gNB-CU and one or more gNB-DUs. In this regard, steps or functions described herein as being performed by the base station 302 or gNB may be performed in a distributed manner. For example, a network node that implements the higher layer functionality may “initiate” transmission of a particular message (e.g., by sending the message to another network node that implements the lower layer(s)), thereby causing the other network node that implements the lower layer functionality to actually transmit the particular message.

As illustrated, the base station 302 sends, and the WCD 312 receives, a configuration of the configuredDLwithUndetectedSFI parameter (step 800). As discussed above, in some embodiments, this configuration of the configuredDLwithUndetectedSFI parameter may be higher layer signaling (e.g., RRC signaling) or lower layer signaling (e.g., a MAC CE). The base station 302 may also send, and the WCD 312 may also receive, a semi-static TDD configuration (step 802). The base station 302 sends, and the WCD 312 receives, a configuration of a set of symbols for configured DL transmission(s), as discussed above (step 804). The base station 302 sends, and the WCD 312 receives, a configuration for the WCD 312 to monitor for DCI Format 2_0 (step 806). Note that steps 800-806 may be performed in any desired order.

The WCD 312 monitors for DCI using DCI format 2_0 (i.e., monitors for a DCI Format 2_0 message or monitors for a DCI that is formatted in accordance with DCI Format 2_0) (step 808). When the WCD 312 does not receive a DCI Format 2_0 message by the start of a set of symbols that indicate a SFI for the set of symbols configured for the configured DL transmission(s) and either: (a) the semi-static TDD configuration received in step 602 indicates that the set of symbols configured for the configured DL transmission(s) are flexible (‘F’) or (b) the WCD 312 did not receive a semi-static TDD configuration, the WCD 312 determines that configured DL transmission(s) on the set of symbols configured for configured DL transmissions are allowed/not allowed based on the configuredDLwithUndetectedSFI parameter, as described above (step 810). The WCD 312 then either receives or refrains from receiving the configured DL transmission(s) on the configured set of symbols in accordance with the determination made in step 810 (step 812).

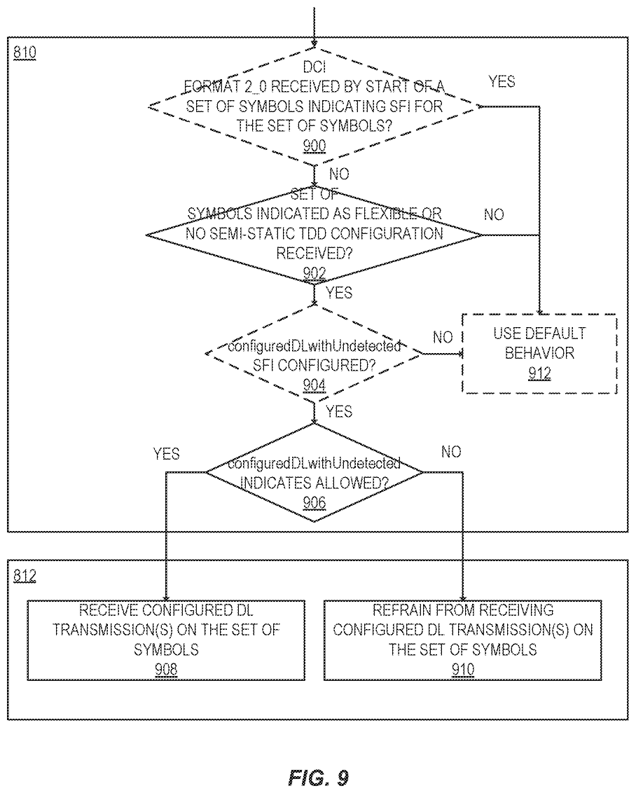

FIG. 9 is a flow chart that illustrates steps 810 and 812 in more detail in accordance with one example embodiment of the present disclosure. Again, optional steps are represented by dashed lines/boxes. As illustrated, the WCD 312 determines whether a DCI Format 2_0 message has been received by the WCD 312 by the start of a set of symbols that indicate a SFI for the set of symbols configured for the configured DL transmission(s) (step 900). If not, the WCD 312 determines whether the semi-static TDD configuration received in step 802 indicates that the set of symbols configured for the configured UL transmission(s) are flexible (‘F’) (if a semi-static TDD configuration was received) or the WCD 312 did not receive a semi-static TDD configuration (step 902). If either (a) the semi-static TDD configuration received in step 802 indicates that the set of symbols configured for the configured UL transmission(s) are flexible (‘F’) or (b) the WCD 312 did not receive a semi-static TDD configuration, the WCD 312 determines whether it was configured with the configuredDLwithUndetectedSFI parameter (step 904). If so, the WCD 312 determines whether the configured configuredDLwithUndetectedSFI parameter indicates that configured DL transmissions are allowed on the set of symbols configured for configured DL transmission(s) (step 906). If so, the WCD 312 receives the configured DL transmission(s) on the configured set of symbols (step 908). If not, the WCD 312 refrains from receiving the configured DL transmission(s) on the configured set of symbols (step 910).

Returning to steps 900, 902, and 904, if the WCD 312 did receive a DCI Format 2_0 by the start of the set of symbols that indicate a SFI for the set of symbols configured for the configured DL transmission(s) or if the set of symbols configured for the configured DL transmission(s) are not indicated as flexible in the semi-static TDD configuration (if a semi-static TDD configuration is received by the WCD 312) or if the WCD 312 is not configured with the configuredDLwithUndetectedSFI parameter, the WCD 312 may, for example, operate in accordance with some predefined default behavior (e.g., as defined by Rel-15 NR specifications) (step 912).

### Embodiment #8

In this embodiment, the parameters and information elements disclosed in the previous embodiments are configured but may be over-ridden inside a channel occupancy initiated by the base station 302 (e.g., a gNB). This is achieved by defining a 1-bit configured uplink indicator (CUL Indicator) field in DCI format 2_0 that controls the behavior of configured UL transmissions within the channel occupancy irrespective of the configuration of and the values taken by the higher layer (e.g., RRC) parameter and Information Elements disclosed in the previous embodiments. A non-limiting example of the procedure taking Embodiment 1 as an example can be described as follows.
RRC parameters and/or Information Elements may be configured as per any of the previous embodiments.
A 1-bit CUL Indicator field is signaled in DCI 2_0 for enabling transmission of all CUL types within the COT duration signaled in the DCI 2_0
   If the CUL Indicator field is ‘0’, the UE assumes behavior corresponding to the RRC parameter (e.g., configuredULwithUndetectedSFI in Embodiment 1) or the fields within Information Elements (e.g., Embodiments 2 or 3) being set to 0.
   If the CUL Indicator field is ‘1’, CUL transmissions are allowed within the signaled COT duration unless DCI 2_0 (same or different from the one that carries the CUL Indicator field) indicates the set of symbols corresponding to the CUL transmission as ‘F’ or ‘D’, i.e., Flexible or Downlink respectively (This is the behavior corresponding to the RRC parameter, configuredULwithUndetectedSFI being set to 1).

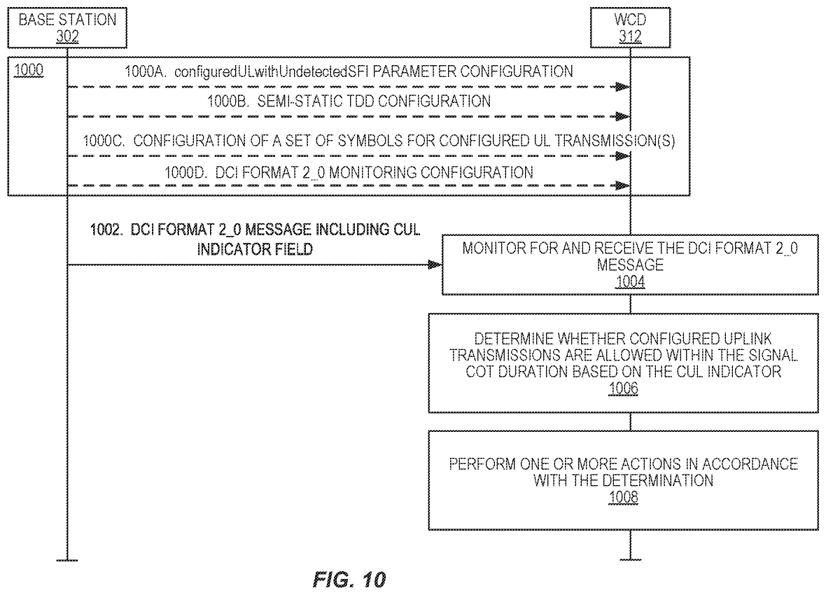

FIG. 10 illustrates the operation of a base station 302 and a WCD 312 in accordance with at least some aspects of Embodiment #8. Again, optional steps are represented by dashed lines/boxes. The steps of the procedure of FIG. 10 are as follows:
Step 1000: Among other things, higher layer (e.g., RRC) parameters and/or Information Elements may be configured as per any of the previous embodiments.
Step 1002: The base station 302 signals a 1-bit CUL Indicator field in a DCI 2_0 message, the CUL Indicator field being for enabling transmission of all CUL types within the COT duration signaled in the DCI 2_0 message.
Step 1004: At the WCD 312, the WCD 312 monitors for and receives the DCI 2_0 message including the CUL Indicator field.
Step 1006: The WCD 312 determines whether configured UL transmissions are allowed within the signaled COT duration based on the value of the CUL Indicator field in the received DCI format 2_0 message. In particular:
   If the CUL Indicator field is set to a first value (e.g., ‘0’), the WCD 312 assumes behavior corresponding to the higher layer (e.g., RRC) parameter (e.g., configuredULwithUndetectedSFI in Embodiment 1) or the fields within Information Elements (e.g., Embodiments 2 or 3) being set to a value(s) that correspond to configured UL transmissions being not allowed.
   If the CUL Indicator field is set to a second value (e.g., ‘1’), CUL transmissions are allowed within the signaled COT duration unless DCI 2_0 (same or different from the one that carries the CUL Indicator field) indicates the set of symbols corresponding to the CUL transmission as ‘F’ or ‘D’, i.e., Flexible or Downlink respectively (This is the behavior corresponding to the RRC parameter, configuredULwithUndetectedSFI being set to 1).
Step 1008: The WCD 312 performs one or more actions based on the determination made in step 1006. Continuing the example from above, if the CUL Indictor is set to the first value, the WCD 312 performs one or more actions in accordance with a determination that default behavior is to be used. Conversely, if the CUL Indicator is set to the second value, the WCD 312 performs the configured UL transmission(s) within the signaled COT unless DCI 2_0 (same or different from the one that carries the CUL Indicator field) indicates the set of symbols corresponding to the CUL transmission as ‘F’ or ‘D’, i.e., Flexible or Downlink respectively (This is the behavior corresponding to the RRC parameter, configuredULwithUndetectecISFI being set to 1).

Note that the process of steps 1002-1008 may be used to override a prior determination of whether CUL transmissions are allowed in accordance with, e.g., any of the embodiments described above.

### Embodiment #9

In this set of embodiments, the higher layer (e.g., RRC) parameters and information elements configured in the previous embodiments are defined so that the differentiation of behavior is based on whether the parameters are configured or not rather than whether the values the parameters or the fields within the Information elements take.

FIG. 11 is a non-limiting example of how this is done using the example of the parameter, named as configuredULwithUndetectedSFI described in Embodiment #1. In particular, FIG. 11 illustrates use of a parameter controlling whether UL transmissions configured by higher layers are allowed. The behavior for cases not shown in this figure is as per Rel-15 NR specifications. As illustrated in FIG. 11, the UE is configured (e.g., by a base station) with a set of symbols for configured UL transmissions (e.g., PUCCH, PUSCH, PRACH, or SRS transmissions, in this example) (step 1100). The UE may also be configured (e.g., by a base station) with a semi-static TDD configuration that indicates the set of symbols as flexible or the UE may not be configured with a semi-static TDD configuration (step 1102). The UE is also configured (e.g., by a base station) for monitoring of DCI Format 2_0 (step 1104). The UE monitors for a DCI Format 2_0 message and does not receive a DCI Format 2_0 message by a time corresponding to ProcTime symbols (e.g., the PUSCH preparation time) before the start of a set of symbols indicating SFI for the set of symbols (step 1106).

In step 1108, the UE determines whether it has been configured (e.g., via higher layer signaling such as, e.g., RRC signaling) with a parameter (configuredULwithUndetectedSFI) that controls whether the UE is allowed to transmit configured UL transmissions in symbols that are indicated as being flexible (‘F’) by a semi-static TDD configuration or for which no indication of transmit direction is received. If the configuredULwithUndetectedSFI has been configured for the UE, the UE determines that the configured UL transmissions are allowed on the set of symbols (step 1110). In other words, the UE transmits the configured UL transmissions on the set of symbols. Conversely, if configuredULwithUndetectedSFI has not been configured, the UE may operate in accordance with default behavior (e.g., in accordance with Rel-NR specifications) (step 1112).

Note that this procedure may be applied to any of the previous embodiments where RRC parameter and/or Information Fields are configured to define the behavior of configured uplink transmissions.

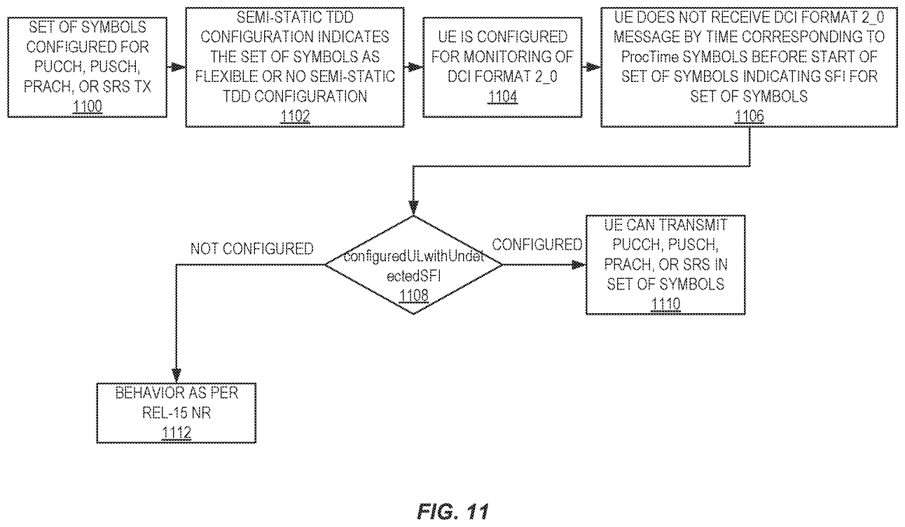

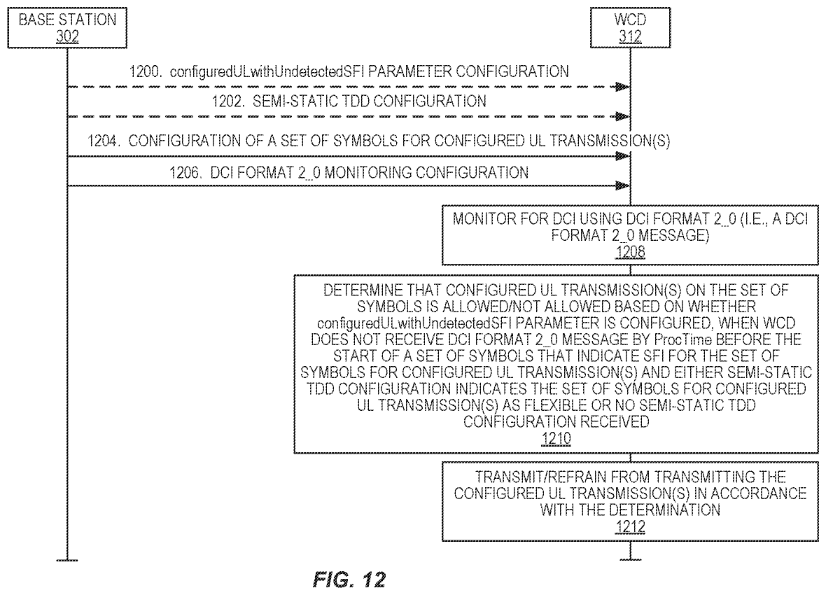

FIG. 12 illustrates the operation of a wireless communication device 312 (e.g., a UE) and a base station 302 (e.g., a gNB) in accordance with at least some aspects of Embodiment #9 described above. Optional steps are represented by dashed lines or dashed boxes. Note that this process is only an example. It should also be noted that while the base station 302 (e.g., gNB) is illustrated as a single box or element, depending on the particular implementation, the base station 302 (e.g., gNB) may be implemented as a single network node or may be distributed across two or more network nodes. For example, the base station 302 may be implemented as two separate network nodes, namely, a first network node that implements, e.g., the PHY and at least a portion of the MAC layer and a second network node that implements higher layers and possibly at portion of the MAC layer. As a specific example, in the case of a gNB, the functionality of the gNB may be separated between a gNB Centralized Unit (gNB-CU) and one or more gNB Distributed Units (gNB-DUs). In this regard, steps or functions described herein as being performed by the base station 302 or gNB may be performed in a distributed manner. For example, a network node that implements the higher layer functionality may “initiate” transmission of a particular message (e.g., by sending the message to another network node that implements the lower layer(s)), thereby causing the other network node that implements the lower layer functionality to actually transmit the particular message.

As illustrated, the base station 302 may configure the WCD 312 with a parameter, denoted here as a configuredULwithUndetectedSFI parameter (step 1200). As discussed above, in some embodiments, this configuration of the configuredULwithUndetectedSFI parameter may be higher layer signaling (e.g., RRC signaling) or lower layer signaling (e.g., a MAC CE). The base station 302 may also send, and the WCD 312 may also receive, a semi-static TDD configuration (step 1202). The base station 302 sends, and the WCD 312 receives, a configuration of a set of symbols for configured UL transmission(s), as discussed above (step 1204). The base station 302 sends, and the WCD 312 receives, a configuration for the WCD 312 to monitor for DCI Format 2_0 (step 1206). Note that steps 1200-1206 may be performed in any desired order.

The WCD 312 monitors for DCI using DCI format 2_0 (i.e., monitors for a DCI Format 2_0 message or monitors for a DCI that is formatted in accordance with DCI Format 2_0) (step 1208). When the WCD 312 does not receive a DCI Format 2_0 message by a time that corresponds to ProcTime (e.g., the PUSCH preparation time) before the start of a set of symbols that indicate a SFI for the set of symbols configured for the configured UL transmission(s) and either: (a) the semi-static TDD configuration received in step 1202 indicates that the set of symbols configured for the configured UL transmission(s) are flexible (‘F’) or (b) the WCD 312 did not receive a semi-static TDD configuration, the WCD 312 determines whether configured UL transmission(s) on the set of symbols configured for configured UL transmissions are allowed/not allowed based on whether the configuredULwithUndetectedSFI parameter has been configured for the WCD 312, as described above (step 1210). The WCD 312 then either transmits or refrains from transmitting the configured UL transmission(s) on the configured set of symbols in accordance with the determination made in step 1210 (step 1212).

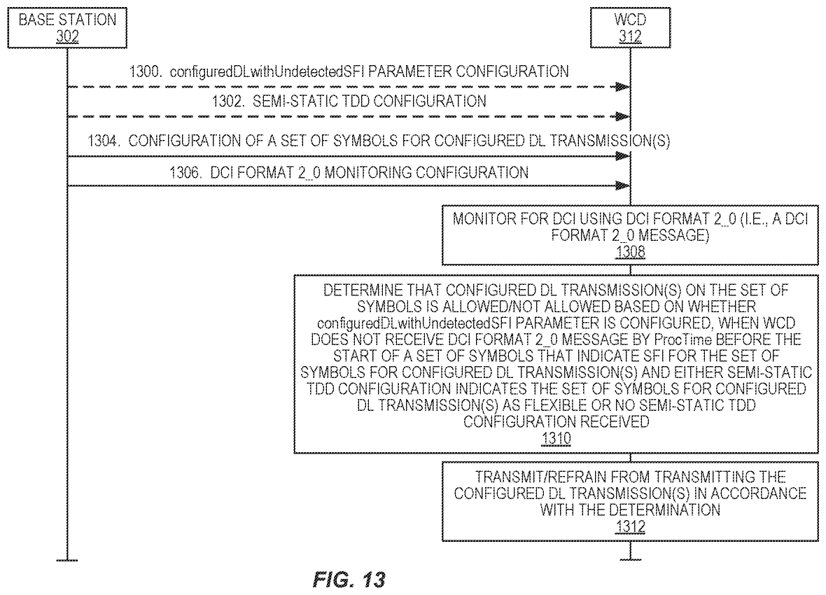

FIG. 13 illustrates another example the operation of a wireless communication device 312 (e.g., a UE) and a base station 302 (e.g., a gNB) in accordance with at least some aspects of Embodiment #9 described above. In this example, the parameter on which the determination is made is the parameter configuredDLwithUndetectedSFI as described above with respect to Embodiment #7. Optional steps are represented by dashed lines or dashed boxes. Note that this process is only an example. It should also be noted that while the base station 302 (e.g., gNB) is illustrated as a single box or element, depending on the particular implementation, the base station 302 (e.g., gNB) may be implemented as a single network node or may be distributed across two or more network nodes. For example, the base station 302 may be implemented as two separate network nodes, namely, a first network node that implements, e.g., the PHY and at least a portion of the MAC layer and a second network node that implements higher layers and possibly at portion of the MAC layer. As a specific example, in the case of a gNB, the functionality of the gNB may be separated between a gNB Centralized Unit (gNB-CU) and one or more gNB Distributed Units (gNB-DUs). In this regard, steps or functions described herein as being performed by the base station 302 or gNB may be performed in a distributed manner. For example, a network node that implements the higher layer functionality may “initiate” transmission of a particular message (e.g., by sending the message to another network node that implements the lower layer(s)), thereby causing the other network node that implements the lower layer functionality to actually transmit the particular message.

As illustrated, the base station 302 may configure the WCD 312 with a parameter, denoted here as a configuredDLwithUndetectedSFI parameter (step 1300). As discussed above, in some embodiments, this configuration of the configuredDLwithUndetectedSFI parameter may be higher layer signaling (e.g., RRC signaling) or lower layer signaling (e.g., a MAC CE). The base station 302 may also send, and the WCD 312 may also receive, a semi-static TDD configuration (step 1302). The base station 302 sends, and the WCD 312 receives, a configuration of a set of symbols for configured DL transmission(s), as discussed above (step 1304). The base station 302 sends, and the WCD 312 receives, a configuration for the WCD 312 to monitor for DCI Format 2_0 (step 1306). Note that steps 1300-1306 may be performed in any desired order.

The WCD 312 monitors for DCI using DCI format 2_0 (i.e., monitors for a DCI Format 2_0 message or monitors for a DCI that is formatted in accordance with DCI Format 2_0) (step 1308). When the WCD 312 does not receive a DCI Format 2_0 message by the start of a set of symbols that indicate a SFI for the set of symbols configured for the configured DL transmission(s) and either: (a) the semi-static TDD configuration received in step 1302 indicates that the set of symbols configured for the configured DL transmission(s) are flexible (‘F’) or (b) the WCD 312 did not receive a semi-static TDD configuration, the WCD 312 determines whether configured DL transmission(s) on the set of symbols configured for configured UL transmissions are allowed/not allowed based on whether the configuredDLwithUndetectedSFI parameter has been configured for the WCD 312, as described above (step 1310). The WCD 312 then either receives or refrains from receiving the configured DL transmission(s) on the configured set of symbols in accordance with the determination made in step 1310 (step 1312).

### Embodiment #10

This is a variation of Embodiment #9 where the procedure is based on the configuration of higher layer (e.g., RRC) parameters and Information Elements as per the set of embodiments in Embodiment #9. A non-limiting example of the procedure as per this set of embodiments is given below.
RRC parameters and/or Information Elements may be configured as per the set of embodiments in Embodiment #9.
A 1-bit CUL Indicator field is signaled in DCI 2_0 for enabling transmission of all CUL types within the COT duration signaled in the DCI 2_0
   If the CUL Indicator field is ‘0’, the UE assumes Rel-15 behavior
   If the CUL Indicator field is ‘1’, CUL transmissions are allowed within the signaled COT duration unless DCI 2_0 (same or different from the one that carries the CUL Indicator field) indicates the set of symbols corresponding to the CUL transmission as ‘F’ or ‘D’, i.e., Flexible or Downlink respectively (This is the behavior corresponding to the RRC parameter, configuredULwithUndetectedSFI being configured).

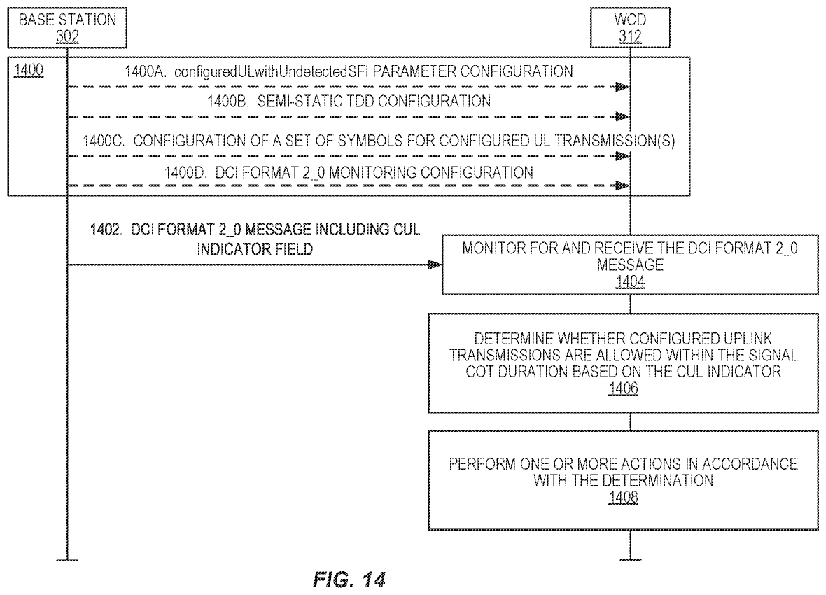

FIG. 14 illustrates the operation of a base station 302 and a WCD 312 in accordance with at least some aspects of Embodiment #10. Again, optional steps are represented by dashed lines/boxes. The steps of the procedure of FIG. 14 are as follows:
Step 1400: Among other things, higher layer (e.g., RRC) parameters and/or Information Elements may be configured as per the set of embodiments in Embodiment #9.
Step 1402: The base station 302 signals a 1-bit CUL Indicator field in a DCI 2_0 message. The CUL Indicator field being for enabling transmission of all CUL types within the COT duration signaled in the DCI 2_0 message.
Step 1404: At the WCD 312, the WCD 312 monitors for and receives the DCI 2_0 message including the CUL Indicator field.
Step 1406: The WCD 312 determines whether configured UL transmissions are allowed within the COT based on the value of the CUL Indicator field in the received DCI format 2_0 message. In particular:
   If the CUL Indicator field is set to a first value (e.g., ‘0’), the WCD 312 assumes default behavior (e.g., Rel-15 behavior).
   If the CUL Indicator field is set to a second value (e.g., ‘1’), CUL transmissions are allowed within the signaled COT duration unless DCI 2_0 (same or different from the one that carries the CUL Indicator field) indicates the set of symbols corresponding to the CUL transmission as ‘F’ or ‘D’, i.e., Flexible or Downlink respectively (This is the behavior corresponding to the RRC parameter, configuredULwithUndetectedSFI being configured).
Step 1408: The WCD 312 performs one or more actions based on the determination made in step 1406. Continuing the example from above, if the CUL Indicator field is set to a first value (e.g., ‘0’), the WCD 312 assumes default behavior (e.g., Rel-15 behavior) and therefore performs one or more actions in accordance with the default behavior. Conversely, if the CUL Indicator is set to the second value, the WCD 312 performs the configured UL transmission(s) within the signaled COT unless DCI 2_0 (same or different from the one that carries the CUL Indicator field) indicates the set of symbols corresponding to the CUL transmission as ‘F’ or ‘D’, i.e., Flexible or Downlink respectively (This is the behavior corresponding to the RRC parameter, configuredULwithUndetectedSFI being configured).

Note that the process of steps 1402-1408 may be used to override a prior determination of whether CUL transmissions are allowed in accordance with, e.g., Embodiment #10.

### Embodiment #11

This set of embodiments includes the set of Embodiments in #9 and #10 with the configuration of higher layer (e.g., RRC) parameters and/or Information Fields being replaced by a determination of whether the system is operating in a band where shared spectrum access is required or not. Specifically, if the system is operating in a licensed band, then the UE assumes Rel-15 behavior and if the system is operating in a band, e.g., band n46 or 46 (as per 3GPP specifications), the UE assumes behavior that is the same as in the set of embodiments in Embodiments #9 and 10 when the RRC parameters and/or Information Fields in these embodiments are configured.

FIG. 15 illustrates the operation of a WCD 312 (e.g., a UE) in accordance with one example of Embodiment #10. As illustrated, the WCD 312 is configured (e.g., by a base station 302) with a set of symbols for configured UL transmissions (e.g., PUCCH, PUSCH, PRACH, or SRS transmissions, in this example) (step 1500). The WCD 312 may also be configured (e.g., by a base station 302) with a semi-static TDD configuration that indicates the set of symbols as flexible or the WCD 312 may not be configured with a semi-static TDD configuration (step 1502). The WCD 312 is also configured (e.g., by a base station 302) for monitoring of DCI Format 2_0 (step 1504). The WCD 312 monitors for a DCI Format 2_0 message and does not receive a DCI Format 2_0 message by a time corresponding to ProcTime symbols (e.g., the PUSCH preparation time) before the start of a set of symbols indicating SFI for the set of symbols (step 1506).

In step 1508, the WCD 312 determines whether it is operating in a licensed band (step 1508). If so, the WCD 312 may operate in accordance with default behavior (e.g., in accordance with Rel-15 NR specifications) (step 1512). However, if the WCD 312 is operating in an unlicensed band (i.e., shared spectrum), the WCD 312 determines whether configured UL transmissions are allowed in accordance with any of the embodiments described above (e.g., in accordance with Embodiment #9 or Embodiment #10) (step 1510). For instance, in order to determine whether configured UL transmissions are allowed in accordance with Embodiment #9, the WCD 312 may make this determination in accordance with steps 1108-1112 of FIG. 11.

### Embodiment #12

Any of embodiments #8-11 in which the 1-bit CUL indicator field signaled in DCI 2_0 enables transmissions of a subset of CUL types (instead of all CUL types).

### Embodiment #13

Any of embodiments #8-12 in which the CUL indicator field consists of a plurality of bits, wherein each bit enables transmissions of a specific CUL type or subset of CUL types.

### Embodiment #14

Any of embodiments #8-13 in which the CUL indicator field is signaled in a DCI format other than DCI 2_0, e.g., DCI 0_1 or any other existing or new DCI format.

### Additional Aspects

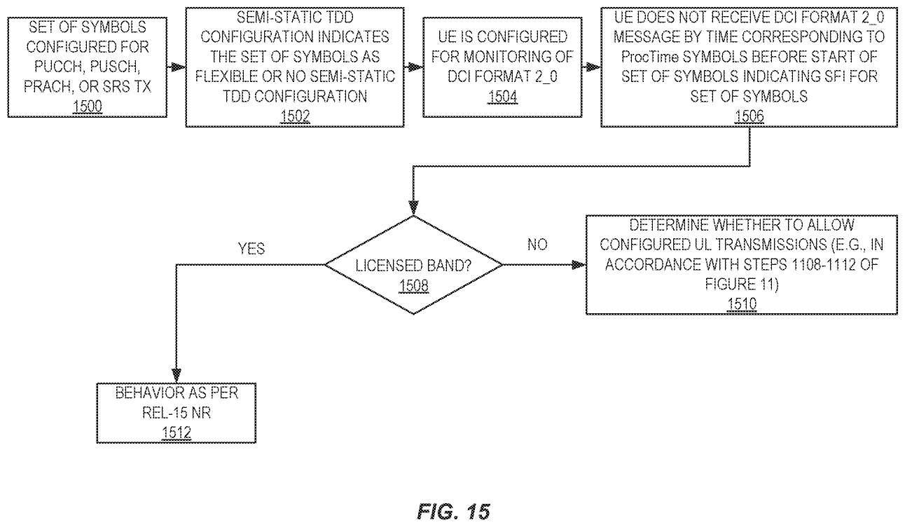

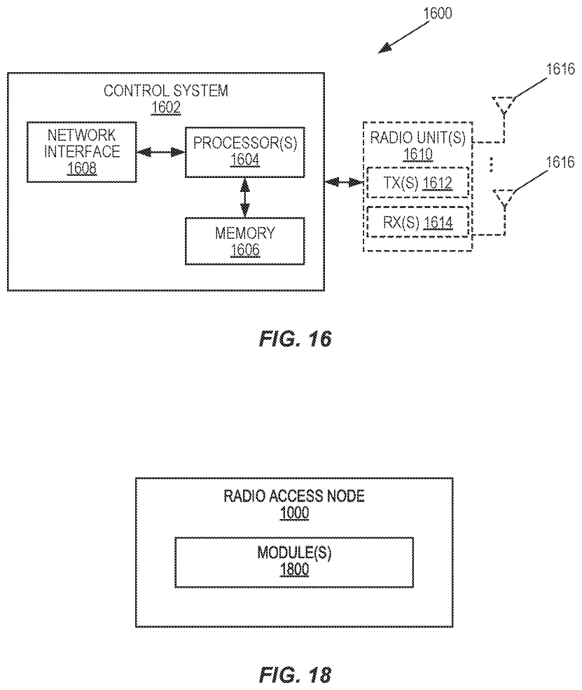

FIG. 16 is a schematic block diagram of a radio access node 1600 according to some embodiments of the present disclosure. Optional features are represented by dashed boxes. The radio access node 1600 may be, for example, a base station 302 or 306 or a network node that implements all or part of the functionality of the base station 302 or gNB described herein (e.g., with respect to Embodiments #1 to #7 described above). As illustrated, the radio access node 1600 includes a control system 1602 that includes one or more processors 1604 (e.g., Central Processing Units (CPUs), Application Specific Integrated Circuits (ASICs), Field Programmable Gate Arrays (FPGAs), and/or the like), memory 1606, and a network interface 1608. The one or more processors 1604 are also referred to herein as processing circuitry. In addition, the radio access node 1600 may include one or more radio units 1610 that each includes one or more transmitters 1612 and one or more receivers 1614 coupled to one or more antennas 1616. The radio units 1610 may be referred to or be part of radio interface circuitry. In some embodiments, the radio unit(s) 1610 is external to the control system 1602 and connected to the control system 1602 via, e.g., a wired connection (e.g., an optical cable). However, in some other embodiments, the radio unit(s) 1610 and potentially the antenna(s) 1616 are integrated together with the control system 1602. The one or more processors 1604 operate to provide one or more functions of a radio access node 1600 as described herein (e.g., with respect to Embodiments #1 to #14 described above). In some embodiments, the function(s) are implemented in software that is stored, e.g., in the memory 1606 and executed by the one or more processors 1604.

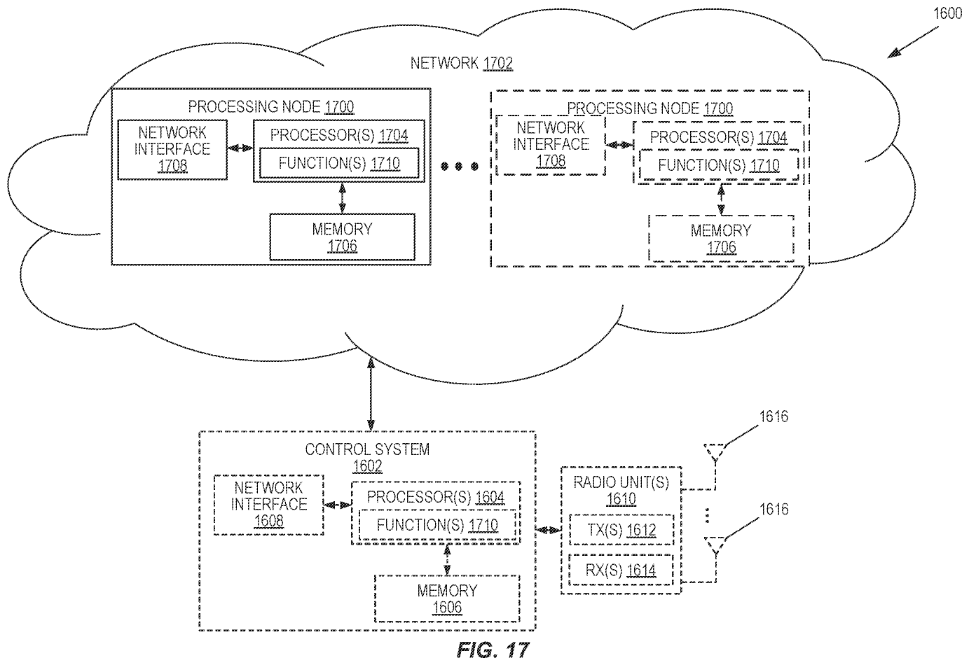

FIG. 17 is a schematic block diagram that illustrates a virtualized embodiment of the radio access node 1600 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1600 in which at least a portion of the functionality of the radio access node 1600 is implemented as a virtual component(s) (e.g., via a virtual machine(s) executing on a physical processing node(s) in a network(s)). As illustrated, in this example, the radio access node 1600 may include the control system 1602 and/or the one or more radio units 1610, as described above. The control system 1602 may be connected to the radio unit(s) 1610 via, for example, an optical cable or the like. The radio access node 1600 includes one or more processing nodes 1700 coupled to or included as part of a network(s) 1702. If present, the control system 1602 or the radio unit(s) are connected to the processing node(s) 1700 via the network 1702. Each processing node 1700 includes one or more processors 1704 (e.g., CPUs, ASICs, FPGAs, and/or the like), memory 1706, and a network interface 1708.

In this example, functions 1710 of the radio access node 1600 described herein (e.g., with respect to Embodiments #1 to #14 described above) are implemented at the one or more processing nodes 1700 or distributed across the one or more processing nodes 1700 and the control system 1602 and/or the radio unit(s) 1610 in any desired manner. In some particular embodiments, some or all of the functions 1710 of the radio access node 1600 described herein are implemented as virtual components executed by one or more virtual machines implemented in a virtual environment(s) hosted by the processing node(s) 1700. As will be appreciated by one of ordinary skill in the art, additional signaling or communication between the processing node(s) 1700 and the control system 1602 is used in order to carry out at least some of the desired functions 1710. Notably, in some embodiments, the control system 1602 may not be included, in which case the radio unit(s) 1610 communicate directly with the processing node(s) 1700 via an appropriate network interface(s).

In some embodiments, a computer program including instructions which, when executed by at least one processor, causes the at least one processor to carry out the functionality of radio access node 1600 or a node (e.g., a processing node 1700) implementing one or more of the functions 1710 of the radio access node 1600 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 18 is a schematic block diagram of the radio access node 1600 according to some other embodiments of the present disclosure. The radio access node 1600 includes one or more modules 1800, each of which is implemented in software. The module(s) 1800 provide the functionality of the radio access node 1600 described herein (e.g., with respect to Embodiments #1 to #14 described above). This discussion is equally applicable to the processing node 1700 of FIG. 17 where the modules 1800 may be implemented at one of the processing nodes 1700 or distributed across multiple processing nodes 1700 and/or distributed across the processing node(s) 1700 and the control system 1602.

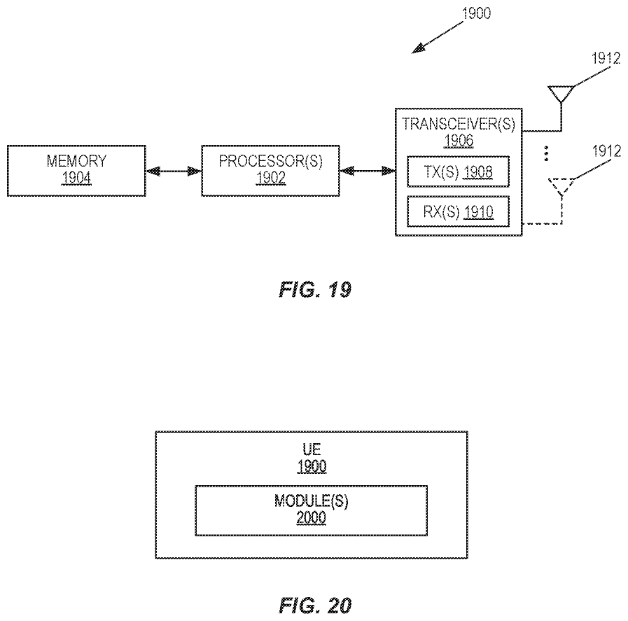

FIG. 19 is a schematic block diagram of a wireless communication device 1900 according to some embodiments of the present disclosure. As illustrated, the wireless communication device 1900 includes one or more processors 1902 (e.g., CPUs, ASICs, FPGAs, and/or the like), memory 1904, and one or more transceivers 1906 each including one or more transmitters 1908 and one or more receivers 1910 coupled to one or more antennas 1912. The transceiver(s) 1906 includes radio-front end circuitry connected to the antenna(s) 1912 that is configured to condition signals communicated between the antenna(s) 1912 and the processor(s) 1902, as will be appreciated by on of ordinary skill in the art. The processors 1902 are also referred to herein as processing circuitry. The transceivers 1906 are also referred to herein as radio circuitry. In some embodiments, the functionality of the wireless communication device 1900 described above (e.g., one or more functions of the WCD 312 or UE described above with respect to Embodiments #1 to #14) may be fully or partially implemented in software that is, e.g., stored in the memory 1904 and executed by the processor(s) 1902. Note that the wireless communication device 1900 may include additional components not illustrated in FIG. 19 such as, e.g., one or more user interface components (e.g., an input/output interface including a display, buttons, a touch screen, a microphone, a speaker(s), and/or the like and/or any other components for allowing input of information into the wireless communication device 1900 and/or allowing output of information from the wireless communication device 1900), a power supply (e.g., a battery and associated power circuitry), etc.

In some embodiments, a computer program including instructions which, when executed by at least one processor, causes the at least one processor to carry out the functionality of the wireless communication device 1900 according to any of the embodiments described herein (e.g., one or more functions of the WCD 312 or UE described above with respect to Embodiments #1 to #14) is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 20 is a schematic block diagram of the wireless communication device 1900 according to some other embodiments of the present disclosure. The wireless communication device 1900 includes one or more modules 1400, each of which is implemented in software. The module(s) 1400 provide the functionality of the wireless communication device 1900 described herein (e.g., one or more functions of the WCD 312 or UE described above with respect to Embodiments #1 to #14).

With reference to FIG. 21, in accordance with an embodiment, a communication system includes a telecommunication network 2100, such as a 3GPP-type cellular network, which comprises an access network 2102, such as a RAN, and a core network 2104. The access network 2102 comprises a plurality of base stations 2106A, 2106B, 2106C, such as Node Bs, eNBs, gNBs, or other types of wireless Access Points (APs), each defining a corresponding coverage area 2108A, 2108B, 2108C. Each base station 2106A, 2106B, 2106C is connectable to the core network 2104 over a wired or wireless connection 2110. A first UE 2112 located in coverage area 2108C is configured to wirelessly connect to, or be paged by, the corresponding base station 2106C. A second UE 2114 in coverage area 2108A is wirelessly connectable to the corresponding base station 2106A. While a plurality of UEs 2112, 2114 are illustrated in this example, the disclosed embodiments are equally applicable to a situation where a sole UE is in the coverage area or where a sole UE is connecting to the corresponding base station 2106.

The telecommunication network 2100 is itself connected to a host computer 2116, which may be embodied in the hardware and/or software of a standalone server, a cloud-implemented server, a distributed server, or as processing resources in a server farm. The host computer 2116 may be under the ownership or control of a service provider, or may be operated by the service provider or on behalf of the service provider. Connections 2118 and 2120 between the telecommunication network 2100 and the host computer 2116 may extend directly from the core network 2104 to the host computer 2116 or may go via an optional intermediate network 2122. The intermediate network 2122 may be one of, or a combination of more than one of, a public, private, or hosted network; the intermediate network 2122, if any, may be a backbone network or the Internet; in particular, the intermediate network 2122 may comprise two or more sub-networks (not shown).

The communication system of FIG. 21 as a whole enables connectivity between the connected UEs 2112, 2114 and the host computer 2116. The connectivity may be described as an Over-the-Top (OTT) connection 2124. The host computer 2116 and the connected UEs 2112, 2114 are configured to communicate data and/or signaling via the OTT connection 2124, using the access network 2102, the core network 2104, any intermediate network 2122, and possible further infrastructure (not shown) as intermediaries. The OTT connection 2124 may be transparent in the sense that the participating communication devices through which the OTT connection 2124 passes are unaware of routing of uplink and downlink communications. For example, the base station 2106 may not or need not be informed about the past routing of an incoming downlink communication with data originating from the host computer 2116 to be forwarded (e.g., handed over) to a connected UE 2112. Similarly, the base station 2106 need not be aware of the future routing of an outgoing uplink communication originating from the UE 2112 towards the host computer 2116.

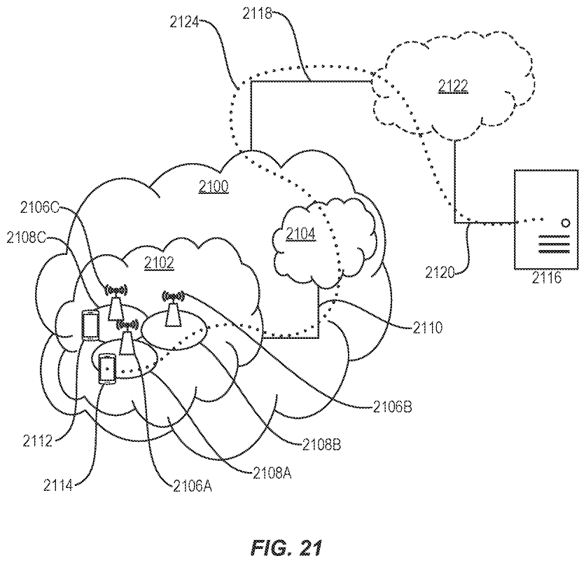

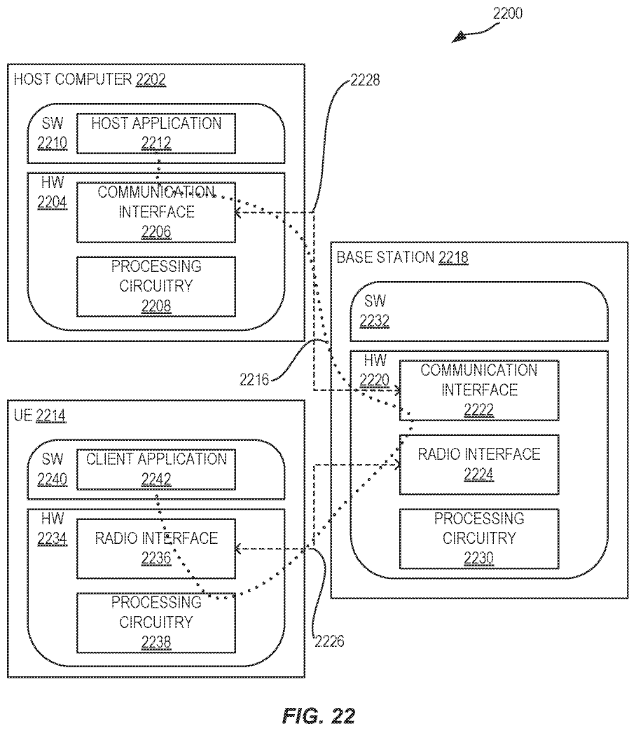

Example implementations, in accordance with an embodiment, of the UE, base station, and host computer discussed in the preceding paragraphs will now be described with reference to FIG. 22. In a communication system 2200, a host computer 2202 comprises hardware 2204 including a communication interface 2206 configured to set up and maintain a wired or wireless connection with an interface of a different communication device of the communication system 2200. The host computer 2202 further comprises processing circuitry 2208, which may have storage and/or processing capabilities. In particular, the processing circuitry 2208 may comprise one or more programmable processors, ASICs, FPGAs, or combinations of these (not shown) adapted to execute instructions. The host computer 2202 further comprises software 2210, which is stored in or accessible by the host computer 2202 and executable by the processing circuitry 2208. The software 2210 includes a host application 2212. The host application 2212 may be operable to provide a service to a remote user, such as a UE 2214 connecting via an OTT connection 2216 terminating at the UE 2214 and the host computer 2202. In providing the service to the remote user, the host application 2212 may provide user data which is transmitted using the OTT connection 2216.

The communication system 2200 further includes a base station 2218 provided in a telecommunication system and comprising hardware 2220 enabling it to communicate with the host computer 2202 and with the UE 2214. The hardware 2220 may include a communication interface 2222 for setting up and maintaining a wired or wireless connection with an interface of a different communication device of the communication system 2200, as well as a radio interface 2224 for setting up and maintaining at least a wireless connection 2226 with the UE 2214 located in a coverage area (not shown in FIG. 22) served by the base station 2218. The communication interface 2222 may be configured to facilitate a connection 2228 to the host computer 2202. The connection 2228 may be direct or it may pass through a core network (not shown in FIG. 22) of the telecommunication system and/or through one or more intermediate networks outside the telecommunication system. In the embodiment shown, the hardware 2220 of the base station 2218 further includes processing circuitry 2230, which may comprise one or more programmable processors, ASICs, FPGAs, or combinations of these (not shown) adapted to execute instructions. The base station 2218 further has software 2232 stored internally or accessible via an external connection.

The communication system 2200 further includes the UE 2214 already referred to. The UE's 2214 hardware 2234 may include a radio interface 2236 configured to set up and maintain a wireless connection 2226 with a base station serving a coverage area in which the UE 2214 is currently located. The hardware 2234 of the UE 2214 further includes processing circuitry 2238, which may comprise one or more programmable processors, ASICs, FPGAs, or combinations of these (not shown) adapted to execute instructions. The UE 2214 further comprises software 2240, which is stored in or accessible by the UE 2214 and executable by the processing circuitry 2238. The software 2240 includes a client application 2242. The client application 2242 may be operable to provide a service to a human or non-human user via the UE 2214, with the support of the host computer 2202. In the host computer 2202, the executing host application 2212 may communicate with the executing client application 2242 via the OTT connection 2216 terminating at the UE 2214 and the host computer 2202. In providing the service to the user, the client application 2242 may receive request data from the host application 2212 and provide user data in response to the request data. The OTT connection 2216 may transfer both the request data and the user data. The client application 2242 may interact with the user to generate the user data that it provides.

It is noted that the host computer 2202, the base station 2218, and the UE 2214 illustrated in FIG. 22 may be similar or identical to the host computer 2116, one of the base stations 2106A, 2106B, 2106C, and one of the UEs 2112, 2114 of FIG. 21, respectively. This is to say, the inner workings of these entities may be as shown in FIG. 22 and independently, the surrounding network topology may be that of FIG. 21.

In FIG. 22, the OTT connection 2216 has been drawn abstractly to illustrate the communication between the host computer 2202 and the UE 2214 via the base station 2218 without explicit reference to any intermediary devices and the precise routing of messages via these devices. The network infrastructure may determine the routing, which may be configured to hide from the UE 2214 or from the service provider operating the host computer 2202, or both. While the OTT connection 2216 is active, the network infrastructure may further take decisions by which it dynamically changes the routing (e.g., on the basis of load balancing consideration or reconfiguration of the network).

The wireless connection 2226 between the UE 2214 and the base station 2218 is in accordance with the teachings of the embodiments described throughout this disclosure. One or more of the various embodiments improve the performance of OTT services provided to the UE 2214 using the OTT connection 2216, in which the wireless connection 2226 forms the last segment.

A measurement procedure may be provided for the purpose of monitoring data rate, latency, and other factors on which the one or more embodiments improve. There may further be an optional network functionality for reconfiguring the OTT connection 2216 between the host computer 2202 and the UE 2214, in response to variations in the measurement results. The measurement procedure and/or the network functionality for reconfiguring the OTT connection 2216 may be implemented in the software 2210 and the hardware 2204 of the host computer 2202 or in the software 2240 and the hardware 2234 of the UE 2214, or both. In some embodiments, sensors (not shown) may be deployed in or in association with communication devices through which the OTT connection 2216 passes; the sensors may participate in the measurement procedure by supplying values of the monitored quantities exemplified above, or supplying values of other physical quantities from which the software 2210, 2240 may compute or estimate the monitored quantities. The reconfiguring of the OTT connection 2216 may include message format, retransmission settings, preferred routing, etc.; the reconfiguring need not affect the base station 2218, and it may be unknown or imperceptible to the base station 2218. Such procedures and functionalities may be known and practiced in the art. In certain embodiments, measurements may involve proprietary UE signaling facilitating the host computer 2202's measurements of throughput, propagation times, latency, and the like. The measurements may be implemented in that the software 2210 and 2240 causes messages to be transmitted, in particular empty or ‘dummy’ messages, using the OTT connection 2216 while it monitors propagation times, errors, etc.

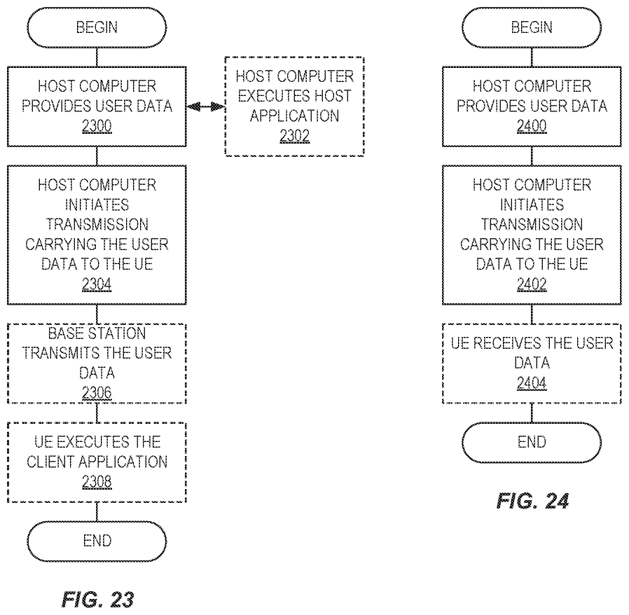

FIG. 23 is a flowchart illustrating a method implemented in a communication system, in accordance with one embodiment. The communication system includes a host computer, a base station, and a UE which may be those described with reference to FIGS. 21 and 22. For simplicity of the present disclosure, only drawing references to FIG. 23 will be included in this section. In step 2300, the host computer provides user data. In sub-step 2302 (which may be optional) of step 2300, the host computer provides the user data by executing a host application. In step 2304, the host computer initiates a transmission carrying the user data to the UE. In step 2306 (which may be optional), the base station transmits to the UE the user data which was carried in the transmission that the host computer initiated, in accordance with the teachings of the embodiments described throughout this disclosure. In step 2308 (which may also be optional), the UE executes a client application associated with the host application executed by the host computer.

FIG. 24 is a flowchart illustrating a method implemented in a communication system, in accordance with one embodiment. The communication system includes a host computer, a base station, and a UE which may be those described with reference to FIGS. 21 and 22. For simplicity of the present disclosure, only drawing references to FIG. 24 will be included in this section. In step 2400 of the method, the host computer provides user data. In an optional sub-step (not shown) the host computer provides the user data by executing a host application. In step 2402, the host computer initiates a transmission carrying the user data to the UE. The transmission may pass via the base station, in accordance with the teachings of the embodiments described throughout this disclosure. In step 2404 (which may be optional), the UE receives the user data carried in the transmission.

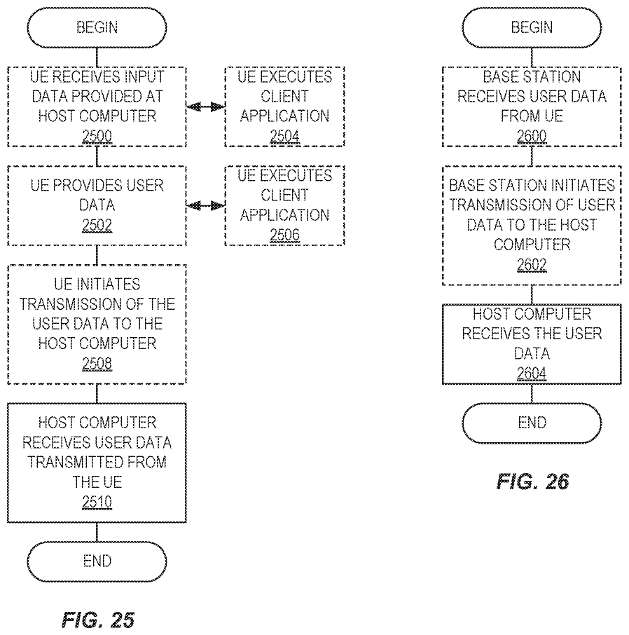

FIG. 25 is a flowchart illustrating a method implemented in a communication system, in accordance with one embodiment. The communication system includes a host computer, a base station, and a UE which may be those described with reference to FIGS. 21 and 22. For simplicity of the present disclosure, only drawing references to FIG. 25 will be included in this section. In step 2500 (which may be optional), the UE receives input data provided by the host computer. Additionally or alternatively, in step 2502, the UE provides user data. In sub-step 2504 (which may be optional) of step 2500, the UE provides the user data by executing a client application. In sub-step 2506 (which may be optional) of step 2502, the UE executes a client application which provides the user data in reaction to the received input data provided by the host computer. In providing the user data, the executed client application may further consider user input received from the user. Regardless of the specific manner in which the user data was provided, the UE initiates, in sub-step 2508 (which may be optional), transmission of the user data to the host computer. In step 2510 of the method, the host computer receives the user data transmitted from the UE, in accordance with the teachings of the embodiments described throughout this disclosure.

FIG. 26 is a flowchart illustrating a method implemented in a communication system, in accordance with one embodiment. The communication system includes a host computer, a base station, and a UE which may be those described with reference to FIGS. 21 and 22. For simplicity of the present disclosure, only drawing references to FIG. 26 will be included in this section. In step 2600 (which may be optional), in accordance with the teachings of the embodiments described throughout this disclosure, the base station receives user data from the UE. In step 2602 (which may be optional), the base station initiates transmission of the received user data to the host computer. In step 2604 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

### Group A Embodiments

Embodiment 1: A method performed by a wireless communication device (312), the method comprising one or more of:
receiving (500) a configuration of a parameter from a base station (302);
receiving (504), from the base station (302), a configuration of a set of symbols for one or more configured uplink transmissions;
receiving (506), from the base station (302), a configuration for monitoring a particular DCI format;
monitoring (508) for a DCI that uses that particular DCI format;
when the wireless communication device (312) does not receive a DCI that uses the particular DCI format by a particular amount of time before a start of a set of symbols that indicate a slot format indicator for the set of symbols configured for the one or more configured uplink transmissions and either: (a) a semi-static TDD configuration received by the wireless communication device (312) indicates the set of symbols configured for the one or more configured uplink transmissions as flexible or (b) the wireless communication device (312) did not receive a semi-static TDD configuration:
   determining (510) whether the one or more configured uplink transmissions are allowed or not based on the configuration of the parameter; and
   either transmitting or refraining from transmitting (512) the one or more configured uplink transmissions on the configured set of symbols for the one or more configured uplink transmissions in accordance with the determining (510).
Embodiment 2: The method embodiment 1 wherein the one or more configured uplink transmissions comprise a PUCCH transmission, a PUSCH transmission, a PRACH transmission, or a SRS transmission.
Embodiment 3: The method of embodiment 1 or 2 wherein the particular DCI format is DCI format 2_0.
Embodiment 4: The method of any of embodiments 1 to 3 wherein the particular amount of time is a physical uplink channel processing delay of the wireless communication device (312).
Embodiment 5: The method of any of embodiments 1 to 4 wherein the configuration of the parameter comprises a single value that indicates whether or not configured uplink transmissions are allowed or not when the wireless communication device (312) does not receive a DCI that uses the particular DCI format by a particular amount of time before a start of a set of symbols that indicate a slot format indicator for the set of symbols configured for the one or more configured uplink transmissions and either: (a) a semi-static TDD configuration received by the wireless communication device (312) indicates the set of symbols configured for the one or more configured uplink transmissions as flexible or (b) the wireless communication device (312) did not receive a semi-static TDD configuration.
Embodiment 6: The method of any of embodiments 1 to 5 wherein the configuration of the parameter comprises a configuration of specific time periods where the parameter is or is not applicable.
Embodiment 7: The method of any of embodiments 1 to 5 wherein the configuration of the parameter comprises different values for the parameter for different time durations or different time periods.
Embodiment 8: The method of any of embodiments 1 to 7 wherein the configuration of the parameter comprises a configuration of one or more specific carriers for which the parameter is applicable.
Embodiment 9: The method of any of embodiments 1 to 7 wherein the configuration of the parameter comprises a configuration of one or more specific uplink signals and/or uplink channels for which the parameter is applicable.
Embodiment 10: The method of any of embodiments 1 to 9 wherein the configuration of the parameter comprises different values for the parameter for different types of uplink transmissions.
Embodiment 11: The method of any of embodiments 1 to 10 wherein the configuration of the parameter comprises different values for the parameter for different LBT bandwidths.
Embodiment 12: The method of any of embodiments 1 to 11 wherein the configuration of the parameter comprises different values for the parameter for licensed and unlicensed spectrum.
Embodiment 13: The method of any of embodiments 1 to 12 further comprising: receiving (1004), from a base station (302), information that indicates whether configured uplink transmissions are allowed within a particular COT duration; making (1006) a determination as to whether configured uplink transmissions are allowed within the particular COT duration based on the information; and performing (1006) one or more actions based on the determination as to whether configured uplink transmissions are allowed.
Embodiment 14: The method of embodiment 13 wherein the determination as to whether configured uplink transmissions are allowed within the particular COT duration overrides the determination as whether the one or more configured uplink transmissions are allowed or not based on the configuration of the parameter.
Embodiment 15: The method of embodiment 13 or 14 wherein receiving (1004) the information that indicates whether configured uplink transmissions are allowed comprises receiving (1004) a DCI message comprising the information.
Embodiment 16: The method of embodiment 15 wherein the DCI message is in a particular DCI format.
Embodiment 17: The method of embodiment 16 wherein the particular DCI format is DCI format 2_0.
Embodiment 18: The method of any of embodiments 15 to 17 wherein the information is 1-bit comprised in a particular field of the DCI message.
Embodiment 19: The method of embodiment 18 wherein particular field is a 1-bit CUL Indicator field of the DCI message.
Embodiment 20: The method of any of embodiments 13 to 19 wherein the information indicates whether all configured uplink transmissions are allowed.
Embodiment 21: The method of any of embodiments 13 to 19 wherein the information indicates whether a particular subset of configured uplink transmissions is allowed.
Embodiment 22: The method of any of embodiments 13 to 19 wherein the information indicates whether one or more particular types of configured uplink transmissions are allowed.
Embodiment 23: The method of any of embodiments 13 to 17 wherein the information comprises a plurality of bits, and each bit of the plurality of bits indicates whether a respective type of a plurality of configured uplink transmissions types is allowed.
Embodiment 24: A method performed by a wireless communication device (312), the method comprising one or more of: receiving (1004), from a base station (302), information that indicates whether configured uplink transmissions are allowed within a particular COT duration; making (1006) a determination as to whether configured uplink transmissions are allowed within the particular COT duration based on the information; and performing (1006) one or more actions based on the determination as to whether configured uplink transmissions are allowed.
Embodiment 25: The method embodiment 24 wherein the configured uplink transmissions comprise a PUCCH transmission, a PUSCH transmission, a PRACH transmission, or a SRS transmission.
Embodiment 26: The method of embodiment 24 or 25 wherein receiving (1004) the information that indicates whether configured uplink transmissions are allowed comprises receiving (1004) a DCI message comprising the information.
Embodiment 27: The method of embodiment 26 wherein the DCI message is in a particular DCI format.
Embodiment 28: The method of embodiment 27 wherein the particular DCI format is DCI format 2_0.
Embodiment 29: The method of any of embodiments 26 to 28 wherein the information is 1-bit comprised in a particular field of the DCI message.
Embodiment 30: The method of embodiment 29 wherein particular field is a 1-bit CUL Indicator field of the DCI message.
Embodiment 31: The method of any of embodiments 24 to 30 wherein the information indicates whether all configured uplink transmissions are allowed.
Embodiment 32: The method of any of embodiments 24 to 30 wherein the information indicates whether a particular subset of configured uplink transmissions is allowed.
Embodiment 33: The method of any of embodiments 24 to 30 wherein the information indicates whether one or more particular types of configured uplink transmissions are allowed.
Embodiment 34: The method of any of embodiments 24 to 28 wherein the information comprises a plurality of bits, and each bit of the plurality of bits indicates whether a respective type of a plurality of configured uplink transmissions types is allowed.
Embodiment 35: A method performed by a wireless communication device (312), the method comprising one or more of:
receiving (1102), from the base station (302), a configuration of a set of symbols for one or more configured uplink transmissions;
receiving (1104), from the base station (302), a configuration for monitoring a particular DCI format; monitoring (1106) for a DCI that uses that particular DCI format;
when the wireless communication device (312) does not receive a DCI that uses the particular DCI format by a particular amount of time before a start of a set of symbols that indicate a slot format indicator for the set of symbols configured for the one or more configured uplink transmissions and either: (a) a semi-static TDD configuration received by the wireless communication device (312) indicates the set of symbols configured for the one or more configured uplink transmissions as flexible or (b) the wireless communication device (312) did not receive a semi-static TDD configuration:
   determining (510) whether the one or more configured uplink transmissions are allowed or not based on whether a parameter is configured; and
   either transmitting or refraining from transmitting (512) the one or more configured uplink transmissions on the configured set of symbols for the one or more configured uplink transmissions in accordance with the determining (510).
Embodiment 36: The method embodiment 35 wherein the one or more configured uplink transmissions comprise a PUCCH transmission, a PUSCH transmission, a PRACH transmission, or a SRS transmission.
Embodiment 37: The method of embodiment 35 or 36 wherein the particular DCI format is DCI format 2_0.
Embodiment 38: The method of any of embodiments 35 to 37 wherein the particular amount of time is a physical uplink channel processing delay of the wireless communication device (312).
Embodiment 39: The method of any of embodiments 36 to 38 wherein determining (510) whether the one or more configured uplink transmissions are allowed or not based on whether a parameter is configured comprises determining (510) that the one or more configured uplink transmissions are allowed if the parameter is configured.
Embodiment 40: The method of any of embodiments 35 to 39 further comprising: receiving (1404) information that indicates whether configured uplink transmissions are allowed within a particular COT duration; making (1406) a determination as to whether configured uplink transmissions are allowed within the particular COT duration based on the information; and performing (1006) one or more actions based on the determination as to whether configured uplink transmissions are allowed.
Embodiment 41: The method of embodiment 40 wherein the determination as to whether configured uplink transmissions are allowed within the particular COT duration overrides the determination as whether the one or more configured uplink transmissions are allowed or not based on whether a parameter is configured.
Embodiment 42: The method of embodiment 40 or 41 wherein receiving (1404) the information that indicates whether configured uplink transmissions are allowed comprises receiving (1404) a DCI message comprising the information.
Embodiment 43: The method of embodiment 42 wherein the DCI message is in a particular DCI format.
Embodiment 44: The method of embodiment 43 wherein the particular DCI format is DCI format 2_0.
Embodiment 45: The method of any of embodiments 42 to 44 wherein the information is 1-bit comprised in a particular field of the DCI message.
Embodiment 46: The method of embodiment 45 wherein particular field is a 1-bit CUL Indicator field of the DCI message.
Embodiment 47: The method of any of embodiments 40 to 46 wherein the information indicates whether all configured uplink transmissions are allowed.
Embodiment 48: The method of any of embodiments 40 to 46 wherein the information indicates whether a particular subset of configured uplink transmissions is allowed.
Embodiment 49: The method of any of embodiments 40 to 46 wherein the information indicates whether one or more particular types of configured uplink transmissions are allowed.
Embodiment 50: The method of any of embodiments 40 to 44 wherein the information comprises a plurality of bits, and each bit of the plurality of bits indicates whether a respective type of a plurality of configured uplink transmissions types is allowed.
Embodiment 51: A method performed by a wireless communication device (312), the method comprising one or more of:
receiving (1500), from the base station (302), a configuration of a set of symbols for one or more configured uplink transmissions;
receiving (1504), from the base station (302), a configuration for monitoring a particular DCI format;
monitoring (1506) for a DCI that uses that particular DCI format;
when the wireless communication device (312) does not receive a DCI that uses the particular DCI format by a particular amount of time before a start of a set of symbols that indicate a slot format indicator for the set of symbols configured for the one or more configured uplink transmissions and either: (a) a semi-static TDD configuration received by the wireless communication device (312) indicates the set of symbols configured for the one or more configured uplink transmissions as flexible or (b) the wireless communication device (312) did not receive a semi-static TDD configuration:
   making (1508) a determination as to whether the one or more configured uplink transmissions are allowed based on whether the wireless communication device (312) is operating in a licensed frequency band; and
   operating (1510; 1512) in accordance with the determination.
Embodiment 52: The method embodiment 51 wherein the one or more configured uplink transmissions comprise a PUCCH transmission, a PUSCH transmission, a PRACH transmission, or a SRS transmission.
Embodiment 53: The method of embodiment 51 or 52 wherein the particular DCI format is DCI format 2_0.
Embodiment 54: The method of any of embodiments 51 to 53 wherein the particular amount of time is a physical uplink channel processing delay of the wireless communication device (312).
Embodiment 55: The method of any of embodiments 51 to 54 further comprising: receiving (1404) information that indicates whether configured uplink transmissions are allowed within a particular COT duration; making (1406) a determination as to whether configured uplink transmissions are allowed within the particular COT duration based on the information; and performing (1006) one or more actions based on the determination as to whether configured uplink transmissions are allowed.
Embodiment 56: The method of embodiment 55 wherein the determination as to whether configured uplink transmissions are allowed within the particular COT duration overrides the determination as whether the one or more configured uplink transmissions are allowed or not based on whether the wireless communication device (312) is operating in a licensed frequency band.
Embodiment 57: The method of embodiment 55 or 56 wherein receiving (1004) the information that indicates whether configured uplink transmissions are allowed comprises receiving (1004) a DCI message comprising the information.
Embodiment 58: The method of embodiment 57 wherein the DCI message is in a particular DCI format.
Embodiment 59: The method of embodiment 58 wherein the particular DCI format is DCI format 2_0.
Embodiment 60: The method of any of embodiments 57 to 59 wherein the information is 1-bit comprised in a particular field of the DCI message.
Embodiment 61: The method of embodiment 60 wherein particular field is a 1-bit CUL Indicator field of the DCI message.
Embodiment 62: The method of any of embodiments 55 to 61 wherein the information indicates whether all configured uplink transmissions are allowed.
Embodiment 63: The method of any of embodiments 55 to 61 wherein the information indicates whether a particular subset of configured uplink transmissions is allowed.
Embodiment 64: The method of any of embodiments 55 to 61 wherein the information indicates whether one or more particular types of configured uplink transmissions are allowed.
Embodiment 65: The method of any of embodiments 55 to 59 wherein the information comprises a plurality of bits, and each bit of the plurality of bits indicates whether a respective type of a plurality of configured uplink transmissions types is allowed.
Embodiment 66: The method of any of the previous embodiments, further comprising: providing user data; and forwarding the user data to a host computer via the transmission to the base station.

### Group B Embodiments

Embodiment 67: A method performed by a base station, the method comprising: transmitting or initiating transmission of (1002; 1402) a configured uplink indicator being indicative of whether configured uplink transmissions are allowed during a particular COT duration.
Embodiment 68: The method of any of the previous embodiments, further comprising: obtaining user data; and forwarding the user data to a host computer or a wireless communication device.

### Group C Embodiments

Embodiment 69: A wireless communication device comprising: processing circuitry configured to perform any of the steps of any of the Group A embodiments; and power supply circuitry configured to supply power to the wireless communication device.
Embodiment 70: A base station comprising: processing circuitry configured to perform any of the steps of any of the Group B embodiments; and power supply circuitry configured to supply power to the base station.
Embodiment 71: A User Equipment, UE, comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.
Embodiment 72: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.
Embodiment 73: The communication system of the previous embodiment further including the base station.
Embodiment 74: The communication system of the previous 2 embodiments, further including the UE, wherein the UE is configured to communicate with the base station.
Embodiment 75: The communication system of the previous 3 embodiments, wherein: the processing circuitry of the host computer is configured to execute a host application, thereby providing the user data; and the UE comprises processing circuitry configured to execute a client application associated with the host application.
Embodiment 76: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.
Embodiment 77: The method of the previous embodiment, further comprising, at the base station, transmitting the user data.
Embodiment 78: The method of the previous 2 embodiments, wherein the user data is provided at the host computer by executing a host application, the method further comprising, at the UE, executing a client application associated with the host application.
Embodiment 79: A User Equipment, UE, configured to communicate with a base station, the UE comprising a radio interface and processing circuitry configured to perform the method of the previous 3 embodiments.
Embodiment 80: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.
Embodiment 81: The communication system of the previous embodiment, wherein the cellular network further includes a base station configured to communicate with the UE.
Embodiment 82: The communication system of the previous 2 embodiments, wherein: the processing circuitry of the host computer is configured to execute a host application, thereby providing the user data; and the UE's processing circuitry is configured to execute a client application associated with the host application.
Embodiment 83: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.
Embodiment 84: The method of the previous embodiment, further comprising at the UE, receiving the user data from the base station.
Embodiment 85: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.
Embodiment 86: The communication system of the previous embodiment, further including the UE.
Embodiment 87: The communication system of the previous 2 embodiments, further including the base station, wherein the base station comprises a radio interface configured to communicate with the UE and a communication interface configured to forward to the host computer the user data carried by a transmission from the UE to the base station.
Embodiment 88: The communication system of the previous 3 embodiments, wherein: the processing circuitry of the host computer is configured to execute a host application; and the UE's processing circuitry is configured to execute a client application associated with the host application, thereby providing the user data.
Embodiment 89: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.
Embodiment 90: A method implemented in a communication system including a host computer, a base station, and a User Equipment, UE, the method comprising: at the host computer, receiving user data transmitted to the base station from the UE, wherein the UE performs any of the steps of any of the Group A embodiments.
Embodiment 91: The method of the previous embodiment, further comprising, at the UE, providing the user data to the base station.
Embodiment 92: The method of the previous 2 embodiments, further comprising: at the UE, executing a client application, thereby providing the user data to be transmitted; and at the host computer, executing a host application associated with the client application.
Embodiment 93: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.
Embodiment 94: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.
Embodiment 95: The communication system of the previous embodiment further including the base station.
Embodiment 96: The communication system of the previous 2 embodiments, further including the UE, wherein the UE is configured to communicate with the base station.
Embodiment 97: The communication system of the previous 3 embodiments, wherein: the processing circuitry of the host computer is configured to execute a host application; and the UE is configured to execute a client application associated with the host application, thereby providing the user data to be received by the host computer.
Embodiment 98: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.
Embodiment 99: The method of the previous embodiment, further comprising at the base station, receiving the user data from the UE.
Embodiment 100: The method of the previous 2 embodiments, further comprising at the base station, initiating a transmission of the received user data to the host computer.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
CPU Central Processing Unit
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IoT Internet of Things
IP Internet Protocol
LTE Long Term Evolution
MME Mobility Management Entity
MTC Machine Type Communication
NEF Network Exposure Function
NF Network Function
NR New Radio
NRF Network Function Repository Function
NSSF Network Slice Selection Function
OTT Over-the-Top
PC Personal Computer
PCF Policy Control Function
P-GW Packet Data Network Gateway
QoS Quality of Service
RAM Random Access Memory
RAN Radio Access Network
ROM Read Only Memory
RRH Remote Radio Head
RTT Round Trip Time
SCEF Service Capability Exposure Function
SMF Session Management Function
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method performed by a wireless communication device, the method comprising:
receiving, from a base station, a configuration of a set of symbols for one or more configured transmissions;
monitoring for a DCI that uses a particular Downlink Control Information, DCI, format;
when the wireless communication device does not detect a DCI that uses the particular DCI format and either: (a) a semi-static Time Division Duplexing, TDD, configuration received by the wireless communication device indicates the set of symbols configured for the one or more configured transmissions as flexible or (b) the wireless communication device did not receive a semi-static TDD configuration:
making a determination of whether the one or more configured transmissions are allowed to be transmitted or are received based on whether a parameter is configured.

2. The method claim 1 wherein the set of symbols is a set of symbols in a slot.

3. The method of claim 1 wherein making the determination comprises making the determination when the when the wireless communication device does not detect:
a DCI that uses the particular DCI format and provides a slot format for the slot; and
either: (a) a semi-static Time Division Duplexing, TDD, configuration received by the wireless communication device indicates the set of symbols configured for the one or more configured transmissions as flexible or (b) the wireless communication device did not receive a semi-static TDD configuration.

4. The method of claim 1 further comprising receiving, from the base station, a configuration for monitoring the particular DCI format.

5. The method claim 4 wherein the one or more configured transmissions are one or more configured uplink transmissions, and making the determination comprises making the determination of whether the one or more configured uplink transmissions are allowed to be transmitted based on whether the parameter is configured.

6. The method claim 5 further comprising either transmitting or refraining from transmitting the one or more configured uplink transmissions on the configured set of symbols for the one or more configured uplink transmissions in accordance with the determination.

7. The method claim 5 wherein the one or more configured uplink transmissions comprise:
a physical uplink control channel, PUCCH, transmission;
a physical uplink shared channel, PUSCH, transmission;
a physical random access channel, PRACH, transmission; or
a sounding reference signal, SRS, transmission.

8. The method claim 1 wherein the one or more configured transmissions are one or more configured downlink transmissions, and making the determination comprises making the determination of whether the one or more configured downlink transmissions are received based on whether the parameter is configured.

9. The method of claim 8 further comprising either receiving or refraining from receiving the one or more configured downlink transmissions on the configured set of symbols for the one or more configured downlink transmissions in accordance with the determination.

10. The method claim 8 wherein the one or more configured downlink transmissions comprise:
a physical downlink shared channel, PDSCH, transmission; or
a channel state information reference signal, CSI-RS, transmission.

11. The method of claim 1 wherein the particular DCI format is DCI format 2_0.

12. The method of claim 1 wherein the particular DCI format is a DCI format that comprises a slot format indicator.

13. The method of claim 1 wherein the wireless communication device does not detect a DCI that uses the particular DCI format by a particular amount of time before a start of a set of symbols configured for the one or more configured transmissions.

14. The method of claim 13 wherein the particular amount of time is a physical uplink channel processing delay of the wireless communication device.

15. The method of claim 1 further comprising:
receiving a configuration of the parameter;
wherein making the determination of whether the one or more configured transmissions are allowed to be transmitted or are received based on whether the parameter is configured comprises making a determination that the one or more configured transmissions are allowed to be transmitted or are received based on receiving the configuration of the parameter.

16. The method of claim 1 wherein the parameter is a Radio Resource Control, RRC, parameter.

17. The method of claim 1 further comprising:
receiving information that indicates whether configured uplink transmissions are allowed within a particular Channel Occupancy Time, COT, duration;
making a determination of whether configured uplink transmissions are allowed within the particular COT duration based on the information; and
performing one or more actions based on the determination as to whether configured uplink transmissions are allowed within the particular COT duration.

18. The method of claim 17 wherein the determination of whether configured uplink transmissions are allowed within the particular COT duration overrides the determination of whether the one or more configured uplink transmissions are allowed to be transmitted or are received based on whether the parameter is configured.

19. The method of claim 1 wherein the determination is of whether all configured transmissions are allowed to be transmitted or are received.

20. The method of claim 1 wherein the determination is of whether a particular subset of configured transmissions is allowed to be transmitted or are received.

21. The method of claim 1 wherein the determination is of whether one or more particular types of configured transmissions are allowed to be transmitted or are received.

22. The method of claim 1 wherein a configuration of the parameter comprises a configuration of one or more specific time periods when the parameter is or is not applicable.

23. The method of claim 1 wherein a configuration of the parameter comprises different values for the parameter for different time durations or different time periods.

24. (canceled)

25. The method of claim 1 wherein a configuration of the parameter comprises a configuration of one or more specific signals for which the parameter is applicable, a configuration of one or more channels for which the parameter is applicable, or both a configuration of one or more specific signals for which the parameter is applicable and a configuration of one or more channels for which the parameter is applicable.

26-28. (canceled)

29. A wireless communication device adapted to:
receive, from the base station, a configuration of a set of symbols for one or more configured transmissions;
monitor for a DCI that uses a particular DCI format;
when the wireless communication device does not detect a DCI that uses the particular DCI format and either: (a) a semi-static TDD configuration received by the wireless communication device indicates the set of symbols configured for the one or more configured transmissions as flexible or (b) the wireless communication device did not receive a semi-static TDD configuration:
make a determination of whether the one or more configured transmissions are allowed to be transmitted or are received based on whether a parameter is configured.

30. (canceled)

31. A wireless communication device comprising:
one or more transmitters;
one or more receivers; and
processing circuitry associated with the one or more transmitters and the one or more receivers, the processing circuitry configured to cause the wireless communication device to:
receive, from the base station, a configuration of a set of symbols for one or more configured transmissions;
monitor for a DCI that uses a particular DCI format;
when the wireless communication device does not detect a DCI that uses the particular DCI format and either: (a) a semi-static TDD configuration received by the wireless communication device indicates the set of symbols configured for the one or more configured transmissions as flexible or (b) the wireless communication device did not receive a semi-static TDD configuration:
make a determination of whether the one or more configured transmissions are allowed to be transmitted or are received based on whether a parameter is configured.

32-82. (canceled)
